(19) United States
(12) Patent Application Publication
(10) Pub. No.: US 2026/0164295 A1
(43) Pub. Date: Jun. 11, 2026

(54) MANAGING MULTICAST AND UNICAST WIRELESS DATA TRANSMISSION

(71) Applicant: GOOGLE LLC, Mountain View, CA (US)

(72) Inventor: Chih-Hsiang Wu, Taoyuan City (TW)

(21) Appl. No.: 18/701,922

(22) PCT Filed: Oct. 19, 2022
(86) PCT No.: PCT/US2022/047084

§ 371 Date: Apr. 16, 2024

Related U.S. Application Data
(60) Provisional application No. 63/262,880, filed on Oct. 21, 2021.
(60) Provisional application No. 63/270,786, filed on Oct. 22, 2021.
(60) Provisional application No. 63/281,246, filed on Nov. 19, 2021.
(60) Provisional application No. 63/281,244, filed on Nov. 19, 2021.
(60) Provisional application No. 63/281,238, filed on Nov. 19, 2021.

(51) Int. Cl. H04W 28/02; H04W 76/40

(52) U.S. Cl. CPC H04W 28/0268; H04W 76/40

(57) ABSTRACT

A method for managing transmission of multicast and/or broadcast services (MBS), performed by a distributed unit (DU) of a distributed base station in a radio access network (RAN), is provided, including: receiving, from a central unit (CU) of the distributed base station, an MBS data packet via a downlink (DL) tunnel; selecting, based on one or more properties of the DL tunnel, a multicast scheme for transmitting the MBS data packet to multiple UEs; and transmitting the data packet via a radio interface to the multiple UEs using the multicast scheme, in accordance with the selecting. Additionally, a method for managing transmission of data packets, implemented in a node of a RAN, is provided, the method comprising: receiving, from an upstream node, an MBS data packet associated with a quality-of-service (QOS) flow; selecting, based on the QoS flow, a logical channel on a radio interface; and multicasting on the logical channel, the MBS data packet to multiple UEs.

### FIELD OF THE DISCLOSURE

This disclosure relates to wireless communications and, more particularly, to managing multicast and unicast wireless data transmission for multicast and/or broadcast services.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, or an Internet Control Message Protocol (ICMP) layer. Generally, the UE and a base station can use SRBs to exchange RRC messages as well as non-access stratum (NAS) messages, and can use DRBs to transport data on a user plane.

The RRC sublayer specifies the RRC_IDLE state, in which a UE does not have an active radio connection with a base station; the RRC_CONNECTED state, in which the UE has an active radio connection with the base station; and the RRC_INACTIVE state that allows the UE to more quickly transition back to the RRC_CONNECTED state due to Radio Access Network (RAN)-level base station coordination and RAN-paging procedures.

In some scenarios, a UE can operate in a state in which a radio resource control connection with the RAN is not active (e.g., RRC_IDLE or RRC_INACTIVE state) and subsequently transition to the connected state. Generally, in the inactive state, the radio connection between the UE and the RAN is suspended. Later, when the UE is triggered to send data (e.g., outgoing phone call, browser launch) or receives a paging message from the base station, the UE can then transition to the connected state. To carry out the transition, the UE can request that the base station establish a radio connection (e.g., by sending an RRC Setup Request message to the base station) or resume the suspended radio connection (e.g., by sending an RRC Resume Request message to the base station), so that the base station can configure the UE to operate in the connected state.

In some cases, the UE in the RRC_IDLE or RRC_INACTIVE state has only one packet (or only relatively small packets) to transmit, or the base station has only one packet (or only relatively small packets) to transmit to the UE operating in the RRC_IDLE or RRC_INACTIVE state. In these cases, the UE in the RRC_IDLE or RRC_INACTIVE state can perform an early data communication without transitioning to the RRC_CONNECTED state, e.g., by using techniques as specified in 3GPP specification 36.300 v 16.4.0 sections 7.3a-7.3d.

The UE in some scenarios can concurrently utilize resources of multiple nodes (e.g., base stations or components of a distributed base station, also called a disaggregated base station) of a RAN, interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed also called a disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, UEs support a 100 MHz bandwidth in frequency range 1(FR1 ) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IOT) applications, V2X applications, and emergency messages related to public safety, for example.

It has been proposed to provide multicast paging for Multicast and/or Broadcast Services (MBS), that is, by transmitting a multicast paging message or instruction which indicates that UEs that have previously indicated an interest in a particular MBS service and that are not operating in an active state are to be paged for the MBS service. For example, a Core Network (CN) can receive MBS data that is to be transmitted to multiple interested UEs, and based on the received MBS data, the CN can transmit, to a Central Unit (CU) of a distributed base station (BS), a multicast paging message which identifies the set of UEs interested in the MBS service. The CU can transmit one or more corresponding multicast paging messages to Distributed Units (DUs) of the distributed base station, where each CU-to-DU multicast paging message indicates one or more interested UEs associated with the recipient DU.

5G NR supports both multicast and unicast delivery methods for the transmission of MBS packet flows over the radio interface. In unicast communications, a RAN node transmits different copies of each MBS data packet to different UEs over the radio interface, while in multicast communications a RAN node transmits a single copy of each MBS data packet to multiple UEs over the radio interface. In some scenarios, however, it is unclear how a base station receives an MBS data packet from a core network and how the base station transmits each MBS data packet to UEs, including when the base station is implemented in a distributed manner. Moreover, in some scenarios, it is unclear how the base station is to map downlink MBS traffic onto the radio interface, given the two available delivery methods, multicast and unicast.

### SUMMARY

In an embodiment, a method for managing transmission of multicast and/or broadcast services (MBS), performed by a distributed unit (DU) of a distributed base station in a radio access network (RAN), is provided, the method comprising: receiving, from a central unit (CU) of the distributed base station, an MBS data packet via a downlink (DL) tunnel; selecting, based on one or more properties of the DL tunnel, a multicast scheme for transmitting the MBS data packet to multiple UEs; and transmitting the data packet via a radio interface to the multiple UEs using the multicast scheme, in accordance with the selecting.

In another embodiment, a method for managing transmission of data packets, performed by a node of a radio access network (RAN), is provided, the method comprising: receiving, from an upstream node, an MBS data packet associated with a quality-of-service (QoS) flow; selecting, based on the QoS flow, a logical channel on a radio interface; and multicasting, on the logical channel, the MBS data packet to multiple UEs.

### BRIEF DESCRIPTION OF THE DRAWINGS

FIG. 1A is a block diagram of an example wireless communication system in which a core network (CN), a base station (BS), and a User Equipment (UE) can implement the techniques of this disclosure for managing multicast and unicast wireless data transmission for Multicast and/or Broadcast Services (MBS);

FIG. 1B is a block diagram of an example distributed base station (BS) including a central unit (CU) and a distributed unit (DU) that can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a distributed base station;

FIG. 2C is a block diagram of another example protocol stack according to which the UE of FIG. 1A can communicate with a DU and a CU of a base station, including support for F1AP protocol between the CU and DU;

FIG. 2D is a block diagram of an example protocol stack according to which a CU and a DU can communicate user-plane traffic;

FIG. 2E is a block diagram of an example protocol stack according to which a CU and a DU can communicate control-plane traffic;

FIG. 3 is a block diagram illustrating example tunnel architectures for MBS sessions and PDU sessions;

FIG. 4 is a block diagram illustrating example MRBs and DRBs, which a distributed base station can configure for communicating multicast, broadcast, and/or unicast traffic with UEs;

FIG. 5A is a messaging diagram of an example scenario in which a CN and a distributed base station configure resources for transmitting MBS data of an MBS session to multiple UEs;

FIG. 5B is a messaging diagram of a scenario similar to that of FIG. 5A, but with the CN providing a list of UEs joining a non-MBS session prior to, rather than after, configuring a CN-to-BS tunnel for the MBS;

FIG. 6A is a flow diagram illustrating an example method for determining whether to transmit a data packet using multicast or unicast depending on whether the data packet arrived via a common or UE-specific tunnel, which can be implemented in a RAN node of this disclosure;

FIG. 6B is a flow diagram illustrating an example method for determining whether to transmit a data packet using multicast or unicast depending on whether the data packet arrived via a first or second tunnel, which can be implemented in a RAN node of this disclosure;

FIG. 7 is a flow diagram illustrating an example method for determining whether to transmit a data packet using multicast or unicast depending on whether the tunnel via which the data packet arrived has a first transport-layer configuration or a second transport-layer configuration, which can be implemented in a RAN node of this disclosure;

FIG. 8A is a flow diagram illustrating an example method for selecting a first logical channel identifier or a second logical channel identifier for a data packet depending on whether the data packet arrived via a common or UE-specific tunnel, which can be implemented in a RAN node of this disclosure;

FIG. 8B is a flow diagram illustrating an example method for selecting a first logical channel identifier or a second logical channel identifier for a data packet depending on whether the data packet arrived via a first or second tunnel, which can be implemented in a RAN node of this disclosure;

FIG. 9 is a flow diagram illustrating an example method for selecting a first logical channel identifier or a second logical channel identifier for a data packet depending on whether the tunnel via which the data packet arrived has a first transport-layer configuration or a second transport-layer configuration, which can be implemented in a RAN node of this disclosure;

FIG. 10A is a flow diagram illustrating an example method for selecting a group Network Temporary Identifier (G-RNTI) and a first logical channel, or a UE-specific RNTI (C-RNTI) and a second logical channel, for a data packet depending on whether the data packet arrived via a common or UE-specific tunnel, which can be implemented in a RAN node of this disclosure;

FIG. 10B is a flow diagram illustrating an example method for selecting a G-RNTI and a first logical channel, or a C-RNTI and a second logical channel, for a data packet depending on whether the data packet arrived via a first or second tunnel, which can be implemented in a RAN node of this disclosure;

FIG. 11 is a flow diagram illustrating an example method for selecting a G-RNTI and a first logical channel, or a C-RNTI and a second logical channel, for a data packet depending on whether the tunnel via which the data packet arrived has a first transport-layer configuration or a second transport-layer configuration, which can be implemented in a RAN node of this disclosure;

FIG. 12 is a flow diagram illustrating an example method for selecting a first logical channel identifier or a second logical channel identifier for a data packet depending on whether the data packet is associated with a first Quality of Service (QOS) flow identifier or a second QoS flow identifier, which can be implemented in a RAN node of this disclosure;

FIG. 13 is a flow diagram illustrating an example method for determining whether to select a first logical channel identifier or a second logical channel identifier for a data packet depending on whether the data packet is associated with a first QoS flow identifier or a second QoS flow identifier, or to select the second logical channel for the data packet, depending on whether the tunnel via which the data packet arrived has a first transport-layer configuration or a second transport-layer configuration, which can be implemented in a RAN node of this disclosure;

FIG. 14 is a flow diagram illustrating an example method for selecting a first logical channel identifier and a G-RNTI, or a second logical channel identifier and the G-RNTI, for a data packet depending on whether the data packet is associated with a first QoS flow identifier or a second QoS flow identifier, which can be implemented in a RAN node of this disclosure; and

FIG. 15 is a flow diagram illustrating an example method for determining whether to select a first logical channel identifier and a G-RNTI, or a second logical channel identifier and the G-RNTI, for a data packet depending on whether the data packet is associated with a first QoS flow identifier or a second QoS flow identifier, or to select the second logical channel and a C-RNTI for the data packet, depending on whether the tunnel via which the data packet arrived has a first transport-layer configuration or a second transport-layer configuration, which can be implemented in a RAN node of this disclosure.

### DETAILED DESCRIPTION OF THE DRAWINGS

Generally, a radio access network (RAN) node of this disclosure selects between a multicast scheme and a unicast scheme for transmission of a data packet to at least one user equipment (UE) over a radio interface based on how the data packet was received from an upstream node. More particularly, in some implementations, the RAN node can receive a multicast and/or broadcast services (MBS) data packet for multiple UEs via a common DL tunnel and determine that the RAN node should use a multicast scheme to transmit the MBS data packet. The RAN node in different scenarios can be a DU of a distributed base station (and the DL tunnel can operate on the CU-to-DU interface) or a non-distributed base station (and the DL tunnel can operate on the core network (CN) to base station (BS), or CN-to-BS, interface).

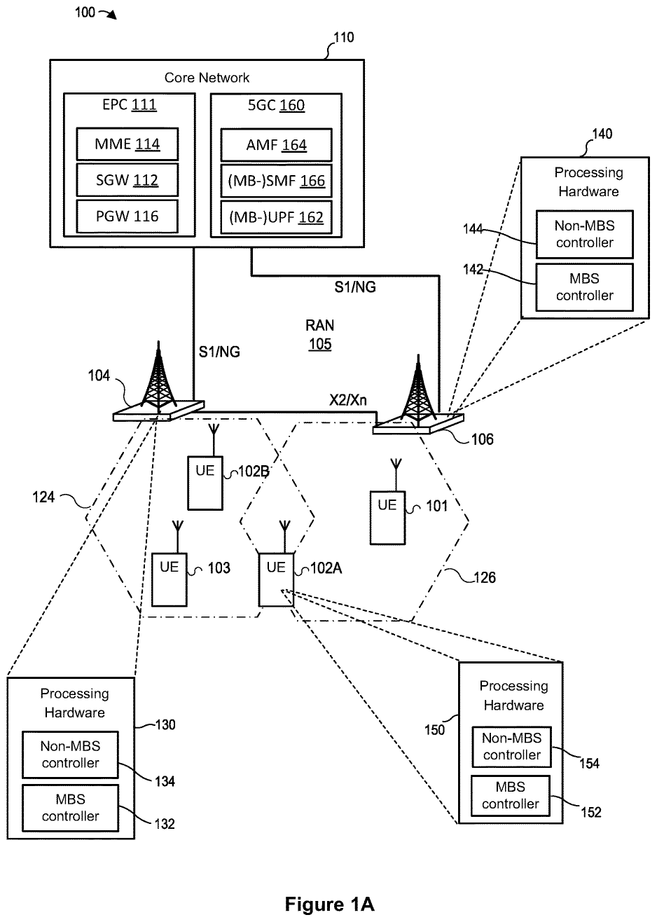

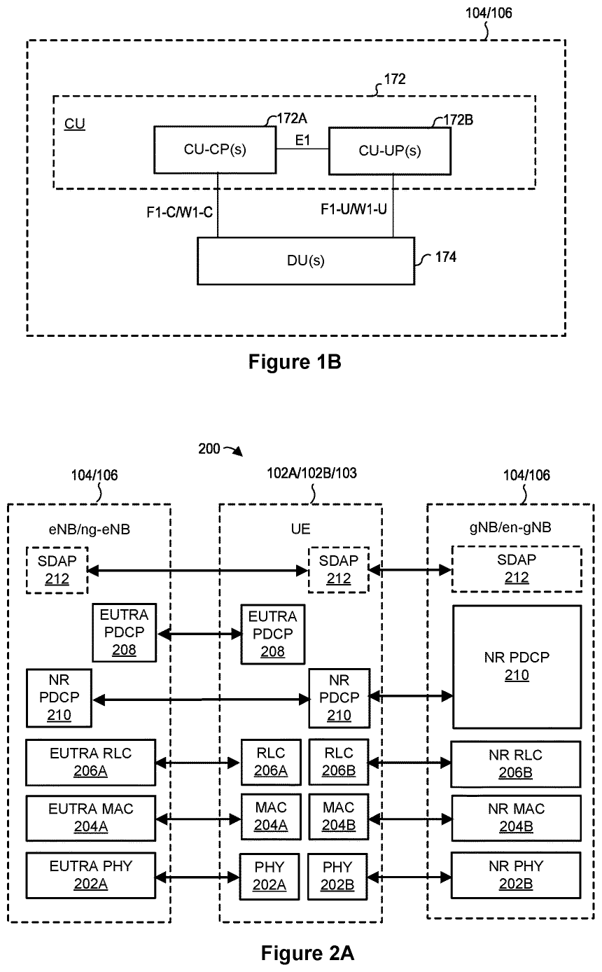

FIG. 1A depicts an example wireless communication system 100 in which techniques of this disclosure for managing transmission and reception of MBS information can be implemented. The wireless communication system 100 includes UEs 102A, 102B, 103, as well as base stations 104, 106 of a RAN 105 connected to a CN 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows for various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission (which can also be referred to as “early data transmission”) in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132, 134 respectively, of base station hardware 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UEs 102B, 103 may each include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 can include a user plane function (UPF) 162 and an access and mobility management function (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast services and MBS services, or for MBS services only, as denoted by the prefix “(MB-)” shown in FIG. 1A.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6 G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of each of one or both of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DU(s) 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

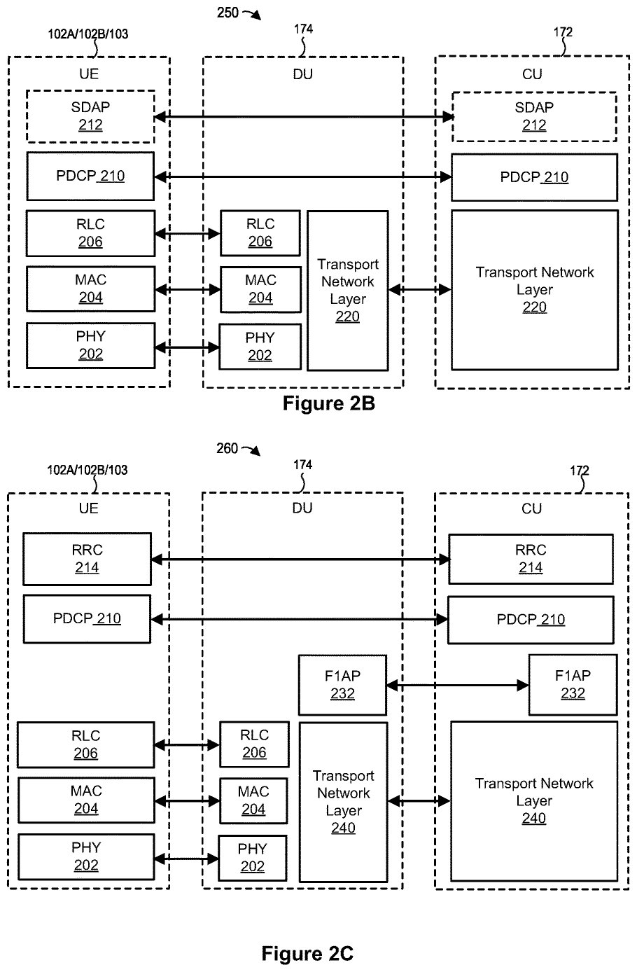

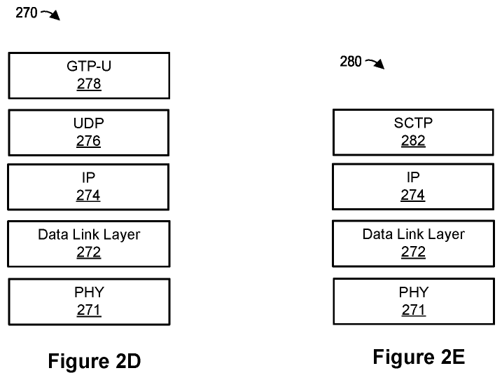

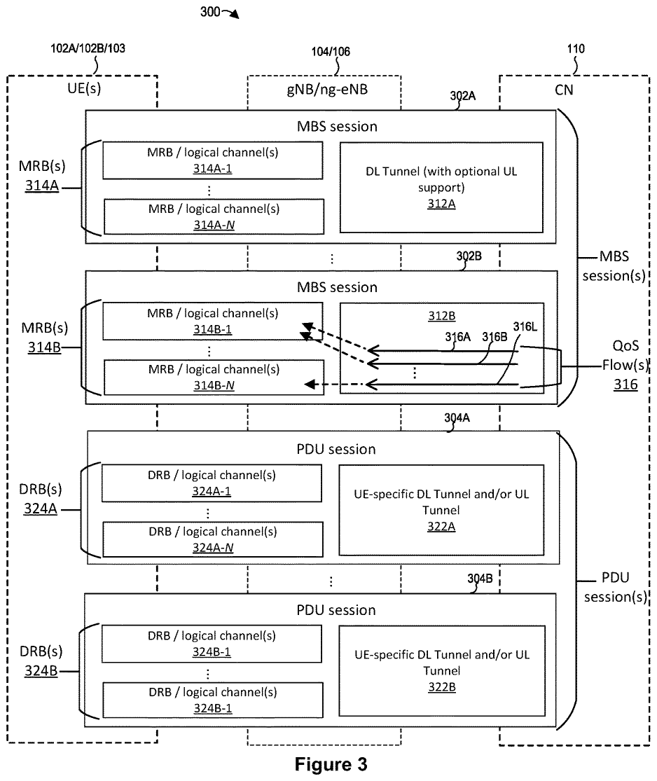

FIG. 2A illustrates, in a simplified manner, an example protocol stack 200 according to which a UE (e.g., UE 102A, 102B, or 103) can communicate with an eNB/ng-eNB or a gNB/en-gNB (e.g., one or both of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A or 102B, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102A or 102B can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, at times this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A, 102B, or 103 operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE 102A or 102B with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104 or 106) broadcasts MBS data packets via one or more MRBs, and in turn the UE 102A or 102B receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A or 102B uses PHY sublayer 202, MAC sublayer 204, and RLC sublayer 206 to receive the MBS data packets. In such implementations, the base station and the UE 102A or 102B may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A of 102B uses PHY sublayer 202, MAC sublayer 204, RLC sublayer 206 and PDCP sublayer 208 to receive the MBS data packets. In such implementations, the base station and the UE 102A or 102B may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A or 102B uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE 102A, 102B, or 103 can use to communicate with a DU (e.g., DU 174) and a CU (e.g., CU 172). The radio protocol stack 200 is functionally split as shown by the radio protocol stack 250 in FIG. 2B. The CU at either of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

FIG. 2C illustrates, in a simplified manner, an example protocol stack 260 which the UE 102A, 102B, or 103 can use to communicate with a DU (e.g., DU 174) and a CU (e.g., CU 172). The protocol stack 260 is generally similar to the protocol stack 250, but here the RRC layer 214 is layered over the PDCP layer 210 to convey RRC messages between a UE and the CU 172, transparently to the DU 174.

FIG. 2D is a block diagram of an example protocol stack 270 according to which the CU 172 and a DU 174 can communicate user-plane traffic. A GTP-U layer 278 is layered over UDP 276, in turn layered over IP 274. The UDP/IP layers 276, 274 reside over a data link layer 272 and a PHY 271 layer. The PHY layer 271 can be a wired link, for example.

FIG. 2E is a block diagram of an example protocol stack 280 according to the CU 172 and a DU 174 can communicate control-plane traffic. The stack 280 is generally similar to the stack 270, but here a Stream Control Transmission Protocol (SCTP) layer 282 resides over the IP layer 274 to convey control messages.

Referring next to FIG. 3, which depicts example architectures 300 for MBS sessions and PDU sessions, an MBS session 302A can include a tunnel 312A with endpoints at the CN 110 and the base station 104/106 (i.e., the base station 104 or the base station 106). The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, the CN 110 and the base station 104/106 use the tunnel 312A for downlink as well as for uplink (UL) MBS traffic to support, for example, commands or service requests from UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . 316L, where L>1. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific UL tunnel 322A corresponding to one or more DRBs 324A, such as a DRB 324A-1, 324A-2, . . . 324A-N. Each of the DRBs 324A can correspond to a respective logical channel, such as a Dedicated Traffic Channel (DTCH). The base station 104/106 and the CN 110 can also maintain one or more other PDU sessions to support unicast traffic between the CN 110 and particular UEs. For example, PDU session 304B can include a UE-specific DL tunnel and/or UE-specific UL tunnel 322B corresponding to one or more DRBs 324B, such as a DRB 324B-1, 324B-2, . . . 324B-N. Each of the DRBs 324B can correspond to a respective logical channel, such as a DTCH.

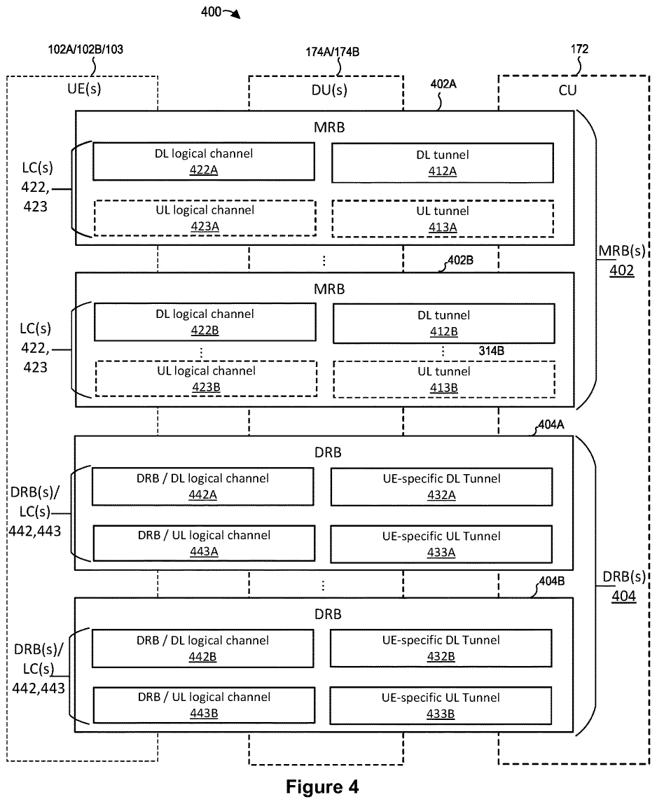

Now referring to FIG. 4, which depicts example MRB(s) and DRB(s) in the case where the base station 104/106 is implemented in a distributed manner, one or more DUs 174 can be associated with the CU 172. The CU 172 and the DU(s) 174 can establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. The MRB 402A can include a DL tunnel 412A connecting the CU 172 and the DU(s) 174, and a DL logical channel 422A corresponding to the DL tunnel 412A. In particular, the DU(s) 174 can map downlink traffic received via the DL tunnel 412A to the DL logical channel 422A, which can be an MTCH or a DTCH, for example. The DL tunnel 412A can be a common DL tunnel via which the CU 172 transmits MBS data packets to multiple UEs. Alternatively, the DL tunnel 412A can be a UE-specific DL tunnel via which the CU 172 transmits MBS data packets to a particular UE.

Optionally, the MRB 402A also includes a UL tunnel 413A connecting the CU 172 and the DU(s) 174, and a UL logical channel 423A corresponding to the UL tunnel 413A.

The UL logical channel 423A can be a DTCH, for example. The DU(s) 174 can map uplink traffic received via the UL logical channel 423A to the UL tunnel 413A.

The tunnels 412A and 413A can operate at the transport layer or sublayer of the F1-U interface. As a more specific example, the CU 172 and the DU(s) 174 can utilize an F1-U for user-plane traffic, and the tunnels 412A and 413A can be associated with the GTP-U protocol layered over UDP/IP, where IP is layered over suitable data link and physical (PHY) layers. Further, the MRB(s) 402 and/or the DRB(s) 404 in at least some of the cases additionally support control-plane traffic. More particularly, the CU 172 and the DU(s) 174 can exchange F1-AP messages over an F1-C interface that relies on a Stream Control Transmission Protocol (SCTP) layered over IP, where IP is layered over suitable data link and PHY layers similar to F1-U.

Similarly, an MRB 402B can include a DL tunnel 412B and, optionally, a UL tunnel 413B. The DL tunnel 412B can correspond to a DL logical channel 422B, and the UL tunnel 413B can correspond to the UL logical channel 423B.

The CU 172 in some cases uses a DRB 404A to transmit MBS data packets or unicast data packets associated with a PDU session, to a particular UE (e.g., the UE 102A or the UE 102B). The DRB 404A can include a UE-specific DL tunnel 432A connecting the CU 172 and the DU(s) 174, and a DL logical channel 442A corresponding to the DL tunnel 432A. In particular, the DU(s) 174 can map downlink traffic received via the DL tunnel 432A to the DL logical channel 442A, which can be a DTCH, for example. The DRB 404A further includes a UE-specific UL tunnel 433A connecting the CU 172 and the DU(s) 174, and a UL logical channel 443A corresponding to the UL tunnel 433A. The UL logical channel 443A can be a PUSCH, for example. The DU(s) 174 can map uplink traffic received via the UL logical channel 443A to the UL tunnel 433A.

Similarly, a DRB 404B can include a UE-specific DL tunnel 432B corresponding to a DL logical channel 442B, and a UE-specific UL tunnel 433B corresponding to a UL logical channel 443B.

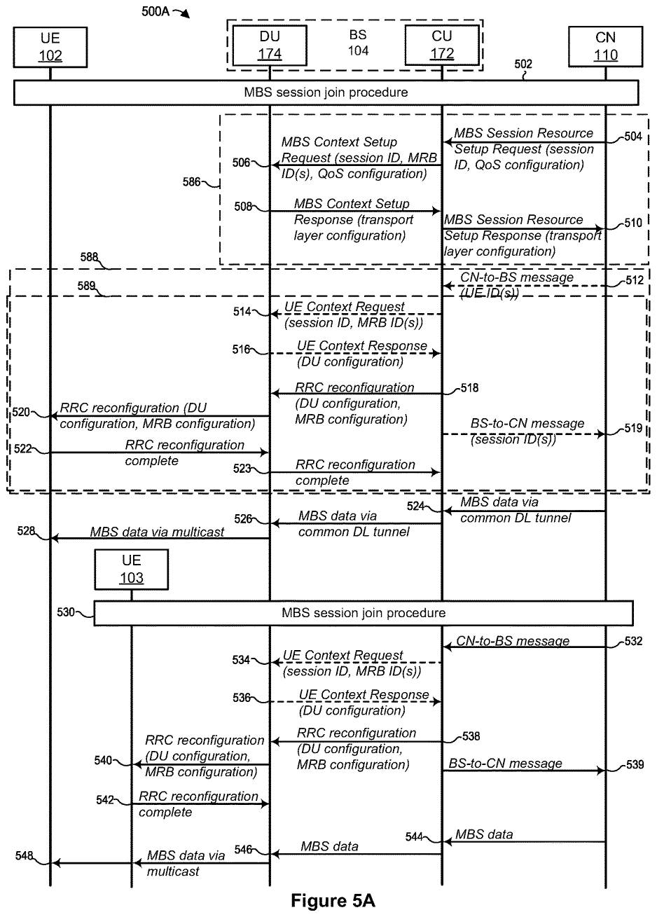

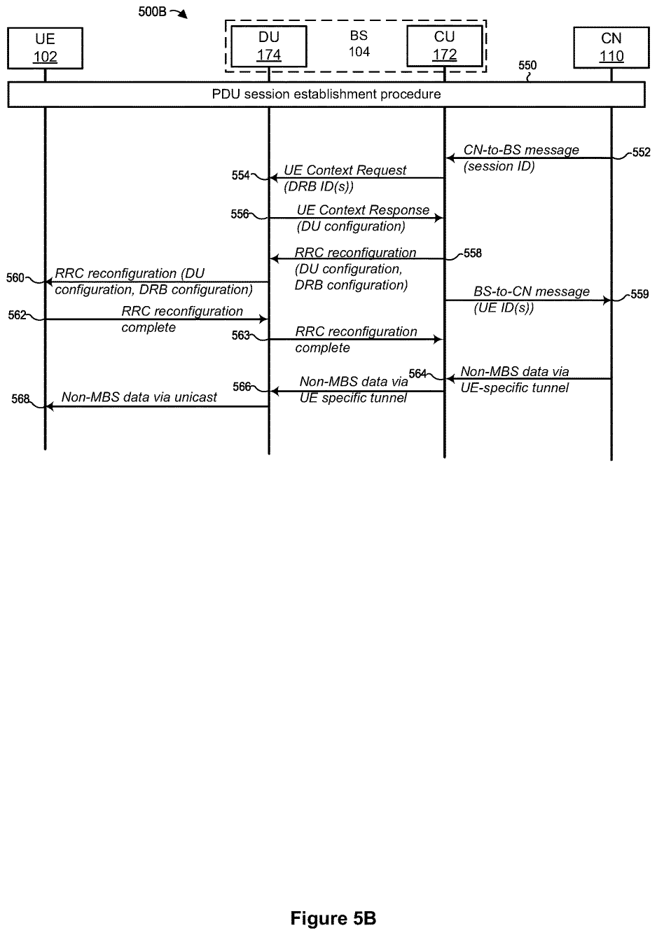

Referring now to FIG. 5A, the UE 102 in a scenario 500A initially performs 502 an MBS session join procedure with the CN 110 via the base station 104 to join a certain MBS session. While FIGS. 5A and 5B depict only a single “UE 102,” it is understood that this can be either or both of UEs 102A, 102B. In some scenarios, the UE 102 subsequently performs additional one or more MBS join procedures, and event 502 accordingly is a first one of multiple MBS join procedures. When the base station 104 configures a common DL tunnel for MBS traffic rather than a UE-specific tunnel, the procedures 502 and 586 can occur in either order. In other words, the base station 104 can configure a common DL tunnel before even a single UE joins the MBS session.

To perform the MBS session join procedure 502, the UE 102 in some implementations sends an MBS session join request message to the CN 110 via the base station 104. In response, the CN 110 can send an MBS session join response message to the UE 102 via the base station 104 to grant the UE 102 access to the first MBS session. In some implementations, the UE 102 can include an MBS session ID of the MBS session in the MBS session join request message. The CN 110 in some cases includes the MBS session ID in the MBS session join response message. In some implementations, the UE 102 can send an MBS session join complete message to the CN 110 via the base station 104 in response to the MBS session join response message.

The UE 102 in some cases performs additional MBS session join procedure(s) with the CN 110 via the RAN 105 (e.g., the base station 104 or base station 106) to join additional MBS session(s). For example, the UE 102 can perform a second MBS session join procedure with the CN 110 via the RAN 105 to join a second MBS session. Similar to event 502, the UE 102 in some implementations can send a second MBS session join request message to the CN 110 via the base station 104, and the CN 110 can respond with a second MBS session join response message to grant the UE 102 access to the second MBS session. In some implementations, the UE 102 can send a second MBS session join complete message to the CN 110 via the base station 104 in response to the second MBS session join response message. In some implementations, the UE 102 can include a second MBS session ID of the second MBS session in the second MBS session join request message. The CN 110 optionally includes the second MBS session ID in the second MBS session join response message. In some implementations, the UE 102 can include the first and second MBS session IDs in an MBS session join request message (e.g., the first MBS session join request message) to request to join the first and second MBS sessions at the same time. In such cases, the CN 110 can send an MBS session response message to grant either the first MBS session or the second MBS session, or both the first and MBS sessions.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management (5GSM) messages. In the case of the 5GSM messages, the UE 102 can transmit to the CN 110 (via the base station 104) a (first) UL container message including the MBS session join request message, the CN 110 can transmit to the UE 102 (via the base station 104) a DL container message including the MBS session join response message, and the UE 102 can transmit to the CN 110 via the base station 104 a (second) UL container message including the MBS session join complete message. These container messages can alternatively be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can also represent their respective container messages.

In some implementations, the UE 102 can perform (not shown) a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

Before, during, or after the (first) MBS session join procedure 502, the CN 110 can send 504 a (first) CN-to-BS message including the first MBS session ID and/or PDU session ID to the CU 172 to request the CU 172 to configure resources for the first MBS session. In response to receiving 504 the first CN-to-BS message, the CU 172 sends 506 a CU-to-DU message to the DU 174 to request a set-up for an MBS context and/or a common DL tunnel for the first MBS session. In response to receiving 506 the CU-to-DU message, the DU 174 sends 508, to the CU 172, a DU-to-CU message including a first DU DL transport layer configuration to configure a common CU-to-DU DL tunnel for the first MBS session (e.g., for an MRB identified by one of the MRB ID(s)). The DU 174 can include, in the DU-to-CU message, additional DL transport layer configuration(s) to configure additional common CU-to-DU DL tunnel(s) for additional MRB(s) identified by additional MRB ID(s) of the MRB IDs. In some implementations, the DU 174 can include, in the DU-to-CU message, the MRB ID(s) associated with the first DL transport layer configuration and/or the additional DL transport layer configuration(s). In some implementations, the CU-to-DU message is a generic F1AP message or a dedicated F1AP message defined specifically to convey this type of a request (e.g., MBS Context Setup Request message). In some implementations, the DU-to-CU message of event 508 is a generic F1AP message or a dedicated F1AP message defined specifically for this purpose (e.g., MBS Context Setup Response message). The CN 110 can additionally include quality of service (QOS) configuration(s) for the first MBS session in the first CN-to-BS message. In such cases, the CU 172 can include the QoS configuration(s) in the CU-to-DU message (event 506).

The CU 172 sends 510 a first BS-to-CN message (e.g., MBS Session Resource Setup Response message) in response to the message of event 504. The CU 172 can include the first MBS session ID and/or the PDU session ID in the first BS-to-CN message. The first BS-to-CN message can include a DL transport layer configuration to configure a common DL tunnel for the CN 110 to send MBS data to the CU 172. The DL transport layer configuration includes a transport layer address (e.g., an IP address and/or a TEID) to identify the common DL tunnel. In some implementations, the CN-to-BS message of event 504 is a generic NGAP message or a dedicated NGAP message defined specifically for requesting resources for an MBS session (e.g., MBS Session Resource Setup Request message). In some implementations, the BS-to-CN message of event 510 is a generic NGAP message or a dedicated NGAP message defined specifically to convey resources for an MBS session (e.g., MBS Session Resource Setup Response message). In such cases, the CN-to-BS message of event 504 and the BS-to-CN message of event 510 can be non-UE-specific messages.

In some implementations, the QoS configuration(s) include QoS parameters for the MBS session. In some implementations, the QoS configuration includes configuration parameters to configure one or more QoS flows for the MBS session (see FIG. 3 and its description above). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, a packet delay budget, a packet error rate, an averaging window, and/or a maximum data burst volume. The CN 110 can specify different values of the QoS parameters for the QoS flows.

The events 504, 506, 508, and 510 are collectively referred to in FIG. 5A as an MBS session resource setup procedure 586.

In cases where the CN 110 grants the additional MBS session(s) for the UE 102 in the additional MBS session join procedure(s), the CN 110 can include the additional MBS session ID(s) and, optionally, QoS configuration(s) for the additional MBS session ID(s) in the first CN-to-BS message, a subsequent CN-to-BS message, or additional CN-to-BS message(s) similar to the first or subsequent CN-to-BS message. In such cases, the CU 172 includes additional transport layer configuration(s) for the additional MBS session(s) to configure additional common DL tunnel(s) in the first BS-to-CN message, a subsequent BS-to-CN message, or additional BS-to-CN message(s) similar to the first or subsequent BS-to-CN message. Each of the transport layer configuration(s) configures a particular common DL tunnel of the common DL tunnel(s) and can be associated to a particular MBS session of the additional MBS session(s). Alternatively, the CN 110 can perform additional MBS session resource setup procedure(s) with the CU 172 to obtain the additional transport layer configuration(s) from the CU 172, similar to the single-session MBS session resource setup procedure 586 shown in FIG. 5A. The transport layer configurations can be different to distinguish between different common DL tunnels. In particular, any pair of the transport layer configurations can have different IP addresses, different DL TEIDs, or different IP addresses, as well as different DL TEIDs.

In some implementations, the CN 110 can indicate, in the first CN-to-BS message, a list of UEs joining the first MBS session. In other implementations, the CN 110 can send 512 to the CU 172 a second CN-to-BS message indicating a list of UEs joining the first MBS session. The CN 110 can include the first MBS session ID and/or the PDU session ID in the second CN-to-BS message. The CU 172 can send 519 a second BS-to-CN message to the CN 110 in response to the second CN-to-BS message 512. In such cases, the second CN-to-BS message can be a non-UE-specific message, e.g., a message not specific for the UE 102A or the UE 102B. The CU 172 can include the first MBS session ID and/or the PDU session ID in the second BS-to-CN message. For example, the list of UEs may include the UE 102A and/or UE 102B. To indicate a list of UEs, the CN 110 can include a list of (CN UE interface ID, RAN UE interface ID) pairs, each identifying a particular UE of the UEs. The CN 110 assigns the CN UE interface ID, and the CU 172 assigns the RAN UE interface ID. Before the CN 110 sends 512 the list of (CN UE interface ID, RAN UE interface ID) pairs in the second CN-to-BS message, the CU 172 sends (not shown) a BS-to-CN message (e.g., a NGAP message, an INITIAL UE MESSAGE or PATH SWITCH REQUEST message) including the RAN UE interface ID to the CN 110 for each of the UEs, and the CN 110 sends (not shown) a CN-to-BS message (e.g., a NGAP message, an INITIAL CONTEXT SETUP REQUEST message or PATH SWITCH REQUEST ACKNOWLEDGE message) including the CN UE interface ID to the CU 172 for each of the UEs. In one example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID”. In other implementations, the CN 110 can include a list of UE IDs each identifying a particular UE of the UEs. In some implementations (not shown), the CN 110 can assign the UE IDs and send each of the UE IDs to a particular UE of the UEs in a NAS procedure (e.g., a registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs). Before the CN 110 sends 512 the list of UE IDs, the CU 172 can receive (not shown) the UE ID from the UE 102 or the CN 110 for each of the UEs. For example, the CU 172 can receive (not shown) an RRC message (e.g., a RRCSetupComplete message) including the UE ID from the UE 102 during an RRC connection establishment procedure. In another example, the CU 172 can receive (not shown) a CN-to-BS message (e.g., a NGAP message, an INITIAL CONTEXT SETUP REQUEST message or UE INFORMATION TRANSFER message) including the UE ID from the CN 110.

In other implementations, the CN 110 can send 512 to the CU 172 a second CN-to-BS message indicating (only) the UE 102 (e.g., either the UE 102A or the UE 102B) that joins the first MBS session. The second CN-to-BS message can be a UE-associated message for the UE 102. That is, the second CN-to-BS message is specific for the UE 102. In response to receiving the second CN-to-BS message, the CU 172 can send 514 to the DU 174 a UE Context Request message for the UE 102. In some implementations, the CU 172 can include, in the UE Context Request message, the first MBS session ID and/or MRB ID(s) of MRB(s) associated to the first MBS session (ID). In response to the UE Context Request message, the DU 174 sends 516 to the CU 172 a UE Context Response message including configuration parameters for the UE 102 to receive MBS data of the first MBS session. In some implementations, the CU 172 can include QoS configuration(s) in the UE Context Request message. In such cases, the CU 172 might or might not include the QoS configuration(s) in the CU-to-DU message sent 506 during the MBS session resource setup procedure 586. (Some of) the configuration parameters may be associated to the MRB(s)/MRB ID(s). In some implementations, the DU 174 generates a DU configuration to include the configuration parameters and includes the DU configuration in the UE Context Response message. In some implementations, the DU configuration can be a CellGroupConfig IE. In other implementations, the DU configuration can be an MBS specific IE. In some implementations, the configuration parameters configure one or more logical channels (LCs). For example, the configuration parameters can include one or more logical channel IDs (LCIDs) to configure the one or more logical channel. Each of the LCIDs identifies a particular logical channel of the one or more logical channels.

In some implementations, the second CN-to-BS message and the second BS-to-CN message can be a PDU Session Resource Modify Request message and a PDU Session Resource Modify Response message, respectively. In some implementations, the second CN-to-BS message and the second BS-to-CN message can be UE-associated messages, i.e., the messages are associated to a particular UE (e.g., the UE 102A or 102B).

In cases where the CN 110 grants the additional MBS session(s) for the UE 102 in the additional MBS session join procedure(s), the CN 110 can include the additional MBS session ID(s) and/or QoS configuration(s) for the additional MBS session ID(s) in the first CN-to-BS message or the second CN-to-BS message. In such cases, the CU 172 can include the additional MBS session ID(s) and MRB ID(s) in the CU-to-DU message, and the DU 174 include, in the DU-to-CU message, additional DU transport layer configuration(s) to configure additional CN-to-BS DL tunnel(s) for the additional MBS session(s). Alternatively, the CU 172 can perform additional MBS session resource setup procedure(s) with the DU 174 to obtain the additional DU DL transport layer configuration(s), similar to the events 506 and 508. In some implementations, the CU 172 includes, in the first BS-to-CN message, additional CU DL transport layer configuration(s) for the additional MBS session(s) to configure additional CN-to-BS common DL tunnel(s). Each of the transport layer configuration(s) configures a particular DL tunnel of the common CN-to-BS DL tunnel(s) and can be associated to a particular MBS session of the additional MBS session(s). Alternatively, the CN 110 can perform additional MBS session resource setup procedure(s) with the CU 172 to obtain the additional CU DL transport layer configuration(s) from the CU 172, similar to the MBS session resource setup procedure 586. The transport layer configurations can be different to distinguish between different common DL tunnels. In particular, any pair of the transport layer configurations can have different IP addresses, different DL TEIDs, or different IP addresses as well as different DL TEIDs.

In some implementations, the CN 110 includes the QoS configuration(s) in the second CN-to-BS message. In such cases, the CN 110 may include the QoS configuration(s) in the first CN-to-BS message, or omit the QoS configuration(s). In some implementations, the DU 174 generates the configuration parameters for the UE 102 to receive MBS data of the first MBS session in response receiving 506 the CU-to-DU message or receiving 514 the UE Context Request message. In some implementations, the CU 172 includes the QoS configuration(s) in the UE Context Request message and/or the CU-to-DU message. The DU 174 can determine the content of the configuration parameters in accordance with the QoS configuration(s). When the CU 172 includes the QoS configuration(s) in neither the CU-to-DU message nor the UE Context Request message, the DU 174 can determine values of the configuration parameters in accordance with a predetermined (default) QoS configuration.

In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively.

After receiving 516 the UE Context Response message, the CU 172 generates an RRC reconfiguration message including the configuration parameters and one or more MRB configurations and transmits 518 the RRC reconfiguration message to the DU 174. In turn, the DU 174 transmits 520 the RRC reconfiguration message to the UE 102. The UE 102 then transmits 522 an RRC reconfiguration complete message (e.g., RRCReconfigurationComplete message) to the DU 174, which in turn transmits 523 the RRC reconfiguration complete message to the CU 172.

The events 512, 514, 516, 518, 519, 520, 522, and 523 are collectively referred to in FIG. 5A as an MBS radio connection reconfiguration procedure 588. The events 514, 516, 518, 520, 522, and 523 are collectively referred to in FIG. 5A as an MBS radio connection reconfiguration procedure 589.

In some implementations, the CU 172 generates a PDCP PDU including the RRC reconfiguration message and sends 518 a CU-to-DU message including the PDCP PDU to the DU 174, and the DU 174 retrieves the PDCP PDU from the CU-to-DU message and transmits 520 the PDCP PDU to the UE 102 via the RLC layer 206B, MAC layer 204B, and PHY layer 202B. The UE 102 receives 520 the PDCP PDU from the DU 174 via the PHY layer 202B, MAC layer 204B and RLC layer 206B. In some implementations, the UE 102 generates a PDCP PDU including the RRC reconfiguration complete message and transmits 522 the PDCP PDU to the DU 174 via the RLC layer 206B, MAC layer 204B, and PHY layer 202B. The DU 174 receives 522 the PDCP PDU from the UE 102 via the PHY layer 202B, MAC layer 204B, and RLC layer 206B and sends 523 a DU-to-CU message including the PDCP PDU to the CU 172. The CU 172 retrieves the PDCP PDU from the DU-to-CU message and retrieves the RRC reconfiguration complete message from the PDCP PDU.

Before or after receiving 516 the UE Context Response message, the CU 172 can send 519 a second BS-to-CN message to the CN 110 in response to the second CN-to-BS message 512. In some implementations, the CU 172 sends 519 the second BS-to-CN message to the CN 110 before receiving 523 the RRC reconfiguration complete message. In other implementations, the CN 110 sends 519 the second BS-to-CN message to the CN 110 after receiving 523 the RRC reconfiguration complete message. The CU 172 can include the first CN UE interface ID and the first RAN UE interface ID in the second BS-to-CN message. Alternatively, the CU 172 can include the first UE ID in the second BS-to-CN message.

In some implementations, respective instances of the MBS radio connection reconfiguration procedure 588 occur for each of the UE 102A and the UE 102B. The configuration parameters for the UE 102A and the UE 102B to receive MBS data of the first MBS session can be the same.

In some implementations, the CU 172 includes the CU DL transport layer configuration(s) in the second BS-to-CN message and/or a subsequent BS-to-CN message.

In other words, the CU 172 can send the same CU DL transport layer configuration(s) in BS-to-CN messages in responses to CN-to-BS messages indicating UEs joining the same MBS session. In such implementations, the CN 110 can blend the MBS resource setup procedure 586 and the MBS radio connection reconfiguration procedure 588 into a single procedure.

In cases where the CU 172 performs the MBS resource setup procedure 586 (e.g., events 504, 510) with the CN 110 to establish the common CN-to-BS DL tunnel for the first MBS session, the CU 172 may refrain from including a DL transport layer configuration for the first MBS session in the second BS-to-CN message. In such cases, the CN 110 may refrain from including a UL transport layer configuration for the first MBS session in the second CN-to-BS message. In cases where the DU 174 performs the MBS resource setup procedure 586 (e.g., events 506, 508) with the CU 172 to establish the common CU-to-DU DL tunnel for the first MBS session, the DU 174 may refrain from including a DL transport layer configuration for the first MBS session in the UE Context Response message. In such cases, the CU 172 may refrain from including a UL transport layer configuration for the first MBS session in the UE Context Request message.

After receiving 510 the first BS-to-CN message or receiving 519 the second BS-to-CN message, the CN 110 can send 524 MBS data (e.g., one or multiple MBS data packets, also interchangeably referred to herein as “MBS content data” or “MBS payload data”) to the CU 172 via the common CN-to-BS DL tunnel, which in turn sends the 526 the MBS data to the DU 174 via the common CU-to-DU tunnel. The DU 174 transmits (e.g., multicast or unicast) 528 the MBS data via the one or more logical channels to the UE 102 (e.g., the UE 102A and/or the UE 102B). The UE 102 receives 528 the MBS data via the one or more logical channels. For example, the CU 172 receives 524 an MBS data packet, generates a PDCP PDU including the MBS data packet and transmits 526 the PDCP PDU to the DU 174. In turn, the DU 174 generates a MAC PDU including the logical channel ID and the PDCP PDU, and transmits 528 the MAC PDU to the UE 102 via multicast or unicast. The UE 102 receives 528 the MAC PDU via multicast or unicast, retrieves the PDCP PDU and the logical channel ID from the MAC PDU, identifies the PDCP PDU associated with the MRB in accordance with the logical channel ID, and retrieves the MBS data packet from the PDCP PDU in accordance with a PDCP configuration within the MRB configuration.

In some implementations, the CU 172 can (determine to) configure a UE-specific CN-to-BS DL tunnel for the UE 102 in response to receiving 504 the first CN-to-BS message or receiving 512 the second CN-to-BS message. In such cases, the CU 172 can omit the event 506, and can include, in the second BS-to-CN message, a DL transport layer configuration configuring a UE-specific DL tunnel. The CN 110 can transmit 524 the MBS data to the CU 172 via the UE-specific CN-to-BS DL tunnel. In some implementations, the CU 172 can (determine to) configure a UE-specific CU-to-DU DL tunnel for the UE 102 in response to receiving 504 the first CN-to-BS message or receiving 512 the second CN-to-BS message. In such cases, the CU 172 can omit the event 510 and the DU 174 can include, in the UE Context Response message, a DL transport layer configuration configuring a UE-specific CU-to-DU DL tunnel. In such cases, the CU 174 can transmit 526 the MBS data to the DU 174 via the UE-specific CU-to-DU DL tunnel.

In some implementations, the one or more MRB configurations configuring one or more MRBs are associated with the first MBS session. In some implementations, the configuration parameters also include one or more RLC bearer configurations, each associated with a particular MRB. Each of the MRB configuration(s) can include a MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel. In some implementations, the logical channel can be a multicast traffic channel (MTCH). In other implementations, the logical channel can be a dedicated traffic channel (DTCH). In some implementations, the configuration parameters may include a logical channel configuration (e.g., LogicalChannelConfig IE) configuring the logical channel. In some implementations, the RLC bearer configuration may include the MRB ID.

In some implementations, the CU 172 can configure the MRB as a DL-only RB in the MRB configuration. For example, the CU 172 refrains from including UL configuration parameters in the PDCP configuration within the MRB configuration to configure the MRB as a DL only RB. The CU 172 only includes DL configuration parameters in the MRB configuration, e.g., as described above. In such cases, the CU 172 configures the UE 102 not to transmit UL PDCP data PDU via the MRB to the DU 174 and/or the CU 172 by excluding the UL configuration parameters for the MRB in the PDCP configuration in the MBR configuration. In another example, the DU 174 refrains from including UL configuration parameters in the RLC bearer configuration. In such cases, the DU 174 configures the UE 102 not to transmit control PDU(s) via the logical channel to the base station 104 by excluding the UL configuration parameters from the RLC bearer configuration.

In cases where the DU 174 includes UL configuration parameter(s) in the RLC bearer configuration, the UE 102 may transmit control PDU(s) (e.g., PDCP Control PDU(s) and/or RLC Control PDU(s)) via the logical channel to the DU 174 using the UL configuration parameter(s). If the control PDU is a PDCP control PDU, the DU 174 can send the PDCP control PDU to the CU 172. For example, the CU 172 may configure the UE 102 to receive MBS data with a (de)compression protocol (e.g., robust header compression (ROHC) protocol), e.g., in the MRB configuration. In this case, when the CU 172 receives 524 an MBS data packet from the CN 110, the CU 172 compresses the MBS data packet with the compression protocol to obtain a compressed MBS data packet and transmits 526 a PDCP PDU including the compressed MBS data packet to the DU 174 via the common CU-to-DU DL tunnel. In turn, the DU 174 transmits (e.g., multicast or unicast) 528 the PDCP PDU to the UE 102 via the logical channel. When the UE 102 receives the PDCP PDU via the logical channel, the UE 102 retrieves the compressed MBS data packet from the PDCP PDU. The UE 102 decompresses the compressed MBS data packet with the (de)compression protocol to obtain the original MBS data packet. In such cases, the UE 102 may transmit a PDCP Control PDU including, a header compression protocol feedback (e.g., interspersed ROHC feedback) for operation of the header (de)compression protocol, via the logical channel to the DU 174. In turn, the DU 174 sends the PDCP Control PDU to the CU 172 via a UE-specific UL tunnel, i.e., the UL tunnel is specific for the UE 102 (e.g., the UE 102A).

In some implementations, the CU 172 can include, in the UE Context Request message, a CU UL transport layer configuration configuring the UE-specific UL tunnel. The CU UL transport layer configuration includes a CU transport layer address (e.g., an Internet Protocol (IP) address) and a CU UL TEID to identify the UE-specific UL tunnel.

In some implementations, the MRB configuration can be an MRB-ToAddMod IE including an MRB ID (e.g., mrb-Identity or MRB-Identity). A MRB ID identifies a particular MRB of the MRB(s). The base station 104 set the MRB IDs to different values. In cases where the CU 172 has configured DRB(s) to the UE 102 for unicast data communication, the CU 172 in some implementations can set one or more of the MRB ID(s) to values different from DRB ID(s) of the DRB(s). In such cases, the UE 102 and the CU 172 can distinguish whether an RB is a MRB or DRB in accordance an RB ID of the RB. In other implementations, the CU 172 can set one or more of the MRB ID(s) to values which can be the same as the DRB ID(s). In such cases, the UE 102 and the CU 172 can distinguish whether an RB is a MRB or DRB in accordance an RB ID of the RB and a RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU 172 can determine an RB is a DRB if the CU 172 transmits a DRB-ToAddMod IE configuring the RB to the UE 102, and determine an RB is an MRB if the CU 172 transmits an MRB-ToAddMod IE configuring the RB to the UE 102.

In some implementations, the configuration parameters for receiving MBS data of the first MBS session include one or more logical channel (LC) IDs to configure one or more logical channels. In some implementations, the logical channel(s) can be DTCH(s). In other implementations, the logical channel(s) can be MTCH(s). In some implementations, the configuration parameters may or may not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the CU 172 can include the MBS session join response message in the RRC reconfiguration message. The UE 102 can include the MBS session join complete message in the RRC reconfiguration complete message. Alternatively, the UE 102 can send a UL RRC message including the MBS session join complete message to the CU 172 via the DU 174. The UL RRC message can be a ULInformationTransfer message or any suitable RRC message that can include a UL NAS PDU. The CU 172 can include the MBS session join complete message in the second BS-to-CN message. Alternatively, the CU 172 can send to the CN 110 a BS-to-CN message (e.g., an UPLINK NAS TRANSPORT message) including the MBS session join complete message.

In other implementations, the CU 172 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the CU 172 via the DU 174. The UL RRC message can be a ULInformationTransfer message, another RRC reconfiguration complete message or any suitable RRC message that can include a UL NAS PDU.

With continued reference to FIG. 5A, the UE 103 can perform 530 an MBS session join procedure similar to the procedure 502 discussed above. The UE 103 can perform a PDU session establishment procedure with the CN 110 via the base station 104 as described with reference to procedure 502. The UE 103 can communicate a PDU session ID with the CN 110 in the PDU session establishment procedure. The UE 103 can join the same MBS session as the UE 102 by sending an MBS session join request and specifying the same MBS session ID. In this example scenario, the UE 103 joins the MBS session after the base station 104 has started transmitting 528 MBS data packets to the UE 102. The CN 110 transmits 532, to the CU 172, a CN-to-BS message including the MBS session ID, and/or the PDU session ID in order to indicate that the UE 103 should start receiving MBS data for an MBS session corresponding to the MBS session ID.

In some scenarios, the CU 172 or CN 110 determines that a DL tunnel for the MBS session identified in the event 532 already exists, and that there is no need to perform the procedure 586. Optionally, however, the CU 172 sends 534 a CU-to-DU message to the DU 174 to trigger an MBS radio connection reconfiguration procedure for the first MBS session similar to event 589, and the DU 174 responds 536 with a DU configuration.

The CU 172 transmits 538 an RRC reconfiguration message to the DU 174, and the DU 174 transmits 540 the RRC reconfiguration message to the UE 103 to configure the UE 103 to receive the MBS traffic. The RRC reconfiguration message can include the same LCID (value), MRB configuration, and RLC bearer configuration as the event 520, when the UE 102 (i.e., UE 102A and/or UE 102B) operate in the same cell as UE 103. When the UEs 102 and 103 operate in different cells, the RRC reconfiguration message can have a different G-RNTI, LCID, and/or RLC bearer configuration, for example. The RRC reconfiguration message can include the same MRB configuration as the event 520, when the UEs 102 and 103 operate in different cells. As illustrated in FIG. 3, the CU 172 can map data packets arriving via the common CN-to-BS DL tunnel to one or more MRBs, each corresponding to a common CU-to-DU DL tunnel and/or a respective logical channel.

The UE 103 transmits 542 an RRC reconfiguration complete message(s) (e.g., RRCReconfigurationComplete message(s)) to the base station 104 (specifically, to the DU 174) in response to the RRC reconfiguration message(s) of event 540. In response to the DU 174 of the base station 104 receiving 542 the RRC reconfiguration complete message, the DU 174 transmits an RRC reconfiguration complete message to the CU 172 (not shown in FIG. 5A). Before or after receiving 542 the RRC reconfiguration complete message(s), the base station 104 in some cases sends 539 another BS-to-CN message to the CN 110, e.g., in a manner generally similar to the event 519. The BS-to-CN message can indicate an updated list of UEs associated with the MBS session specified in the event 532, for example. After the UE 103 has joined 530 the MBS session and obtained (at event 540) the necessary RRC configuration, the CU 172 continues to receive 544 MBS data via the common CN-to-BS DL tunnel and transmits 546 the MBS data to the DU 174 via the common CU-to-DU DL tunnel. In some implementations, the DU 174 transmits 548 the MBS data to the UE 102 and UE 103 via multicast. The UE 102 and UE 103 can receive 548 MBS data similar to event 528.

Alternatively, the base station 104 can transmit 548 the MBS data to the UE 102 and UE 103 separately via unicast.

Referring next to FIG. 5B, a scenario 500B is depicted which is generally similar to the scenario 500A, but with the CN 110 providing a list of UEs joining a non-MBS session prior to, rather than after, configuring a CN-to-BS tunnel for the MBS. Events in this scenario similar to those discussed above are labeled with the same reference numbers and the examples and implementations for FIG. 5A can apply to FIG. 5B. The differences between the scenarios of FIG. 5A and FIG. 5B are discussed below.

The UE 102 performs 550 a PDU session establishment procedure with the CN 110 via the base station 104 similar to procedure 502 but for a non-MBS session. After the procedure 550, the CN 110 transmits 552, to the CU 172, a CN-to-BS message including the PDU session ID. The CU 172 sends 554 a CU-to-DU message to the DU 174 to trigger a reconfiguration procedure for the PDU session, and the DU 174 responds 556 with a DU configuration. The following events 558, 560, 562, 563 are similar to events 518, 520, 522, 523 of FIG. 5A, but for a DRB configuration rather than an MRB configuration. Before or after receiving 562 the RRC reconfiguration complete message(s), the base station 104 in some cases sends 559 another BS-to-CN message to the CN 110, e.g., in a manner generally similar to the event 519. The BS-to-CN message can indicate an updated list of UEs associated with the MBS session specified in the event 552, for example. After the UE 102 has obtained 560 the necessary RRC configuration, the CU 172 continues to receive 564 non-MBS data via the UE-specific CN-to-BS DL tunnel and transmits 566 the non-MBS data to the DU 174 via the UE-specific CU-to-DU DL tunnel and via unicast. The UE 102 can thus receive 568 non-MBS data from the DU 174.

In such cases, the CN 110 can include the additional MBS session ID(s) and, optionally, QoS configuration(s) for the additional MBS session ID(s) in CN-to-BS message(s) in the MBS resource setup and UE-specific MBS session configuration procedure(s), similar to the first or second CN-to-BS message. In such cases, the CU 172 includes additional transport layer configuration(s) for the additional MBS session(s) to configure additional common DL tunnel(s) in BS-to-CN message(s) in the MBS resource setup and UE-specific MBS session configuration procedure(s), similar to the first or second BS-to-CN message. Each of the transport layer configuration(s) configures a particular common DL tunnel of the common DL tunnel(s) and can be associated to a particular MBS session of the additional MBS session(s). The transport layer configurations can be different to distinguish between different common DL tunnels. In particular, any pair of the transport layer configurations can have different IP addresses, different DL TEIDs, or different IP addresses as well as different DL TEIDs.

A UE that is receiving or interested in receiving an MBS can transmit an MBS interest indication to a network (e.g., to a CN 110). Based on the MBS interest indication, the network attempts to enable the UE to receive MBS and unicast services subject to the capabilities of the UE, e.g., the radio capabilities of the UE. In the MBS interest indication, the UE can indicate a set of frequencies (including one or more frequencies) on which the UE is receiving or is interested in receiving MBS. The MBS interest indication can also indicate a list of MBS services that the UE is receiving or is interested in receiving on the indicated one or more frequencies. Further, the UE can transmit the MBS interest indication regardless of whether the serving cell supports MBS. In some cases, the UE can send a first MBS interest indication to the network, and send a second, updated MBS interest indication at a later time.

Generally, a UE (e.g., UE 102A) and/or a RAN (e.g., RAN 105) manage information related to MBS. In response to determining that a radio connection between the UE and the RAN is to be modified, the UE can determine to either retain or release an MBS interest indication. If the UE retains the MBS interest indication, the UE can later transmit an MBS interest indication update to the RAN. If the UE releases the MBS interest indication, the UE may transmit another MBS interest indication to the RAN after modifying the radio connection.

Likewise, a node of the RAN (e.g., base station 104, or DU 174 and/or CU 172) can also receive an MBS interest indication from the UE, and either retain or release the configuration included in the MBS interest indication in response to determining that a radio connection between the UE and the RAN is to be modified. Trigger events that can cause the UE and/or the RAN to determine to release or retain the MBS interest indication may include the UE detecting a failure on the radio connection, or the UE suspending, resuming, or reestablishing the radio connection with the RAN, for example.

Further, MBS interest indications can be stored at the receiving RAN node, at other RAN nodes, and/or at one or more CNs of the wireless communication system. For example, the RAN node receiving an MBS interest indication from a UE can forward the received UE MBS interest indication to another RAN node, to the CN, etc., any of which can forward the UE MBS interest indication to other RAN nodes and/or CNs.

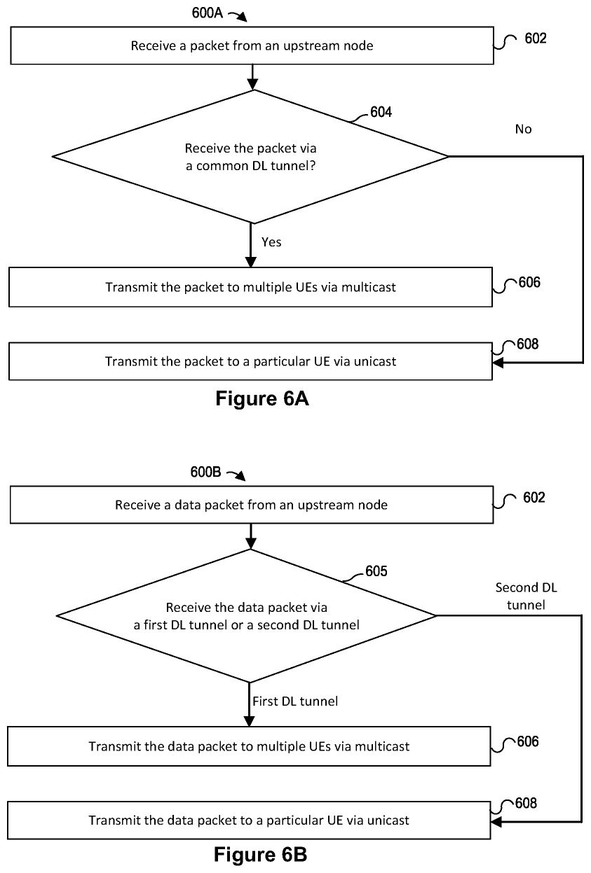

Referring now to FIG. 6A, an example method 600A for determining whether to transmit a data packet using multicast or unicast depending on whether the data packet arrived via a common or UE-specific tunnel can be implemented in a RAN node of this disclosure (e.g., base station 104 or DU 174), for example. The method 600A begins at block 602, where the RAN node receives a data packet from an upstream node (e.g., events 518, 524, 526, 538, 544, 546, 564, 566). At block 604, the RAN node determines whether the data packet was received via a common DL tunnel. If the data packet was received via a common DL tunnel, at block 606, the RAN node transmits the data packet to multiple UEs via multicast (e.g., events 528, 548). If the data packet was not received via a common DL tunnel (e.g., if the data packet was received via a UE-specific DL tunnel, or via a control plane message), at block 608, the RAN node transmits the data packet to a particular UE via unicast (e.g., events 520, 540, 560, 568).

Referring now to FIG. 6B, an example method 600B for determining whether to transmit a data packet using multicast or unicast depending on whether the data packet arrived via a first or second tunnel can be implemented in a RAN node of this disclosure (e.g., base station 104 or DU 174), for example. The method 600B is generally similar to the method 600A, except after block 602, instead of proceeding to block 604 as in the method 600A, the method 600B proceeds to block 605, where the RAN node determines whether the data packet was received via a first DL tunnel or a second DL tunnel. If the data packet was received via the first DL tunnel, at block 606, the RAN node transmits the data packet to multiple UEs via multicast. If the data packet was received via the second DL tunnel, at block 608, the RAN node transmits the data packet to a particular UE via unicast.

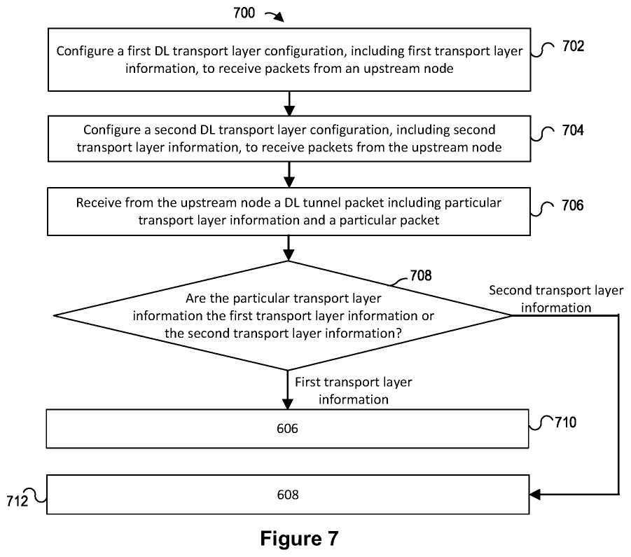

Referring now to FIG. 7, an example method 700 for determining whether to transmit a data packet using multicast or unicast depending on whether the tunnel via which the data packet arrived has a first transport-layer configuration or a second transport-layer configuration can be implemented in a RAN node of this disclosure (e.g., base station 104), for example. The method 700 begins at block 702, where a RAN node configures a first DL transport layer configuration, including first transport layer information, to receive packets from an upstream node (e.g., events 508, 510). At block 704, the RAN node configures a second DL transport layer configuration, including second transport layer information, to receive packets from the upstream node (e.g., events 508, 510). At block 706, the RAN node receives a DL tunnel packet including particular transport layer information and a particular data packet from the upstream node (e.g., events 518, 524, 526, 538, 544, 546, 564, 566). At block 708, the RAN node determines whether the particular transport layer information from the DL tunnel packet is the first transport layer information or the second transport layer information. If the particular transport layer information is the first transport layer information, the method 700 proceeds to block 606, where the RAN node transmits the data packet to multiple UEs via multicast (e.g., events 528, 548). If the particular transport layer information is the second transport layer information, the method 700 proceeds to block 608, where the RAN node transmits the data packet to a particular UE via unicast (e.g., events 520, 540, 560, 568).

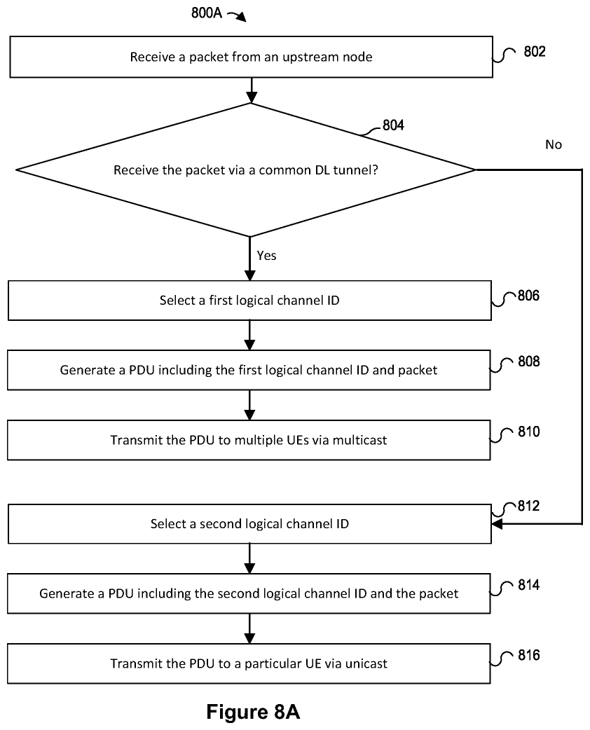

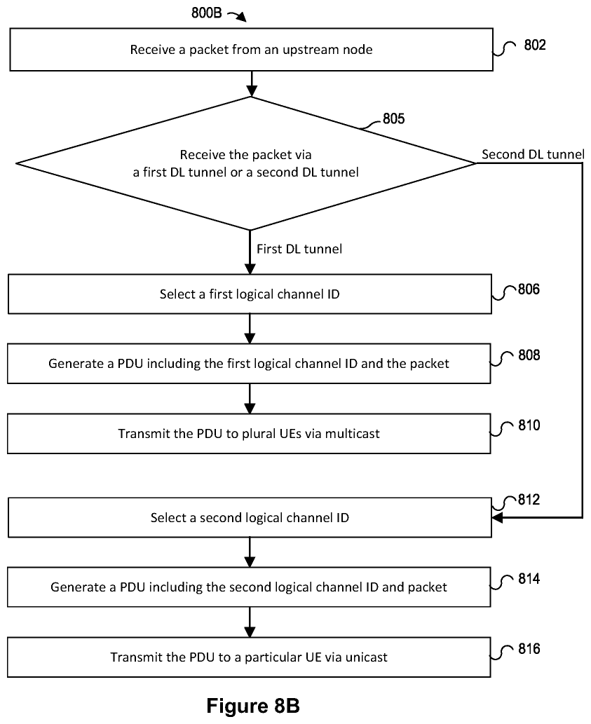

Referring now to FIG. 8A, an example method 800A for selecting a first logical channel identifier or a second logical channel identifier for a data packet depending on whether the data packet arrived via a common or UE-specific tunnel can be implemented in a RAN node of this disclosure (e.g., base station 104 or DU 174), for example. The method 800A begins at block 802, where a RAN node receives a data packet from an upstream node (e.g., events 518, 524, 526, 538, 544, 546, 564, 566). At block 804, the RAN node determines whether the data packet was received via a common DL tunnel. If the data packet was received via a common DL tunnel, at block 806, the RAN node selects a first logical channel ID. At block 808, the RAN node generates a PDU including the first logical channel ID and the data packet. At block 810, the RAN node transmits the PDU to multiple UEs via multicast (e.g., events 528, 548).

If the data packet was not received via a common DL tunnel (e.g., if the data packet was received via a UE-specific DL tunnel, or via a control plane message), at block 812, the RAN node selects a second logical channel ID. At block 814, the RAN node generates a PDU including the second logical channel ID and the data packet. At block 816, the RAN node transmits the PDU to a particular UE via unicast (e.g., events 520, 540, 560, 568).

Referring now to FIG. 8B, an example method 800B for selecting a first logical channel identifier or a second logical channel identifier for a data packet depending on whether the data packet arrived via a first or second tunnel can be implemented in a RAN node of this disclosure (e.g., base station 104 or DU 174), for example. The method 800B is generally similar to the method 800A, except after block 802, instead of proceeding to block 804 as in the method 800A, the method 800B proceeds to block 805, where the RAN node determines whether the data packet was received via a first DL tunnel or a second DL tunnel. If the data packet was received via the first DL tunnel, at block 806, the RAN node selects a first logical channel ID. At block 808, the RAN node generates a PDU including the first logical channel ID and the data packet. At block 810, the RAN node transmits the PDU to multiple UEs via multicast.

If the data packet was not received via the second DL tunnel, at block 812, the RAN node selects a second logical channel ID. At block 814, the RAN node generates a PDU including the second logical channel ID and the data packet. At block 816, the RAN node transmits the PDU to a particular UE via unicast.

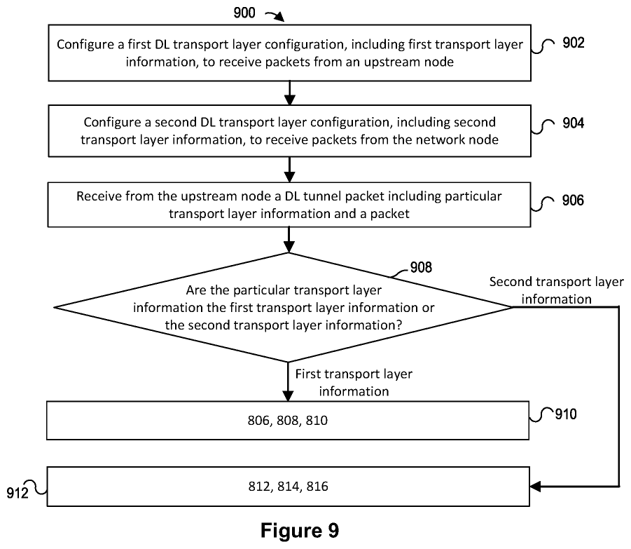

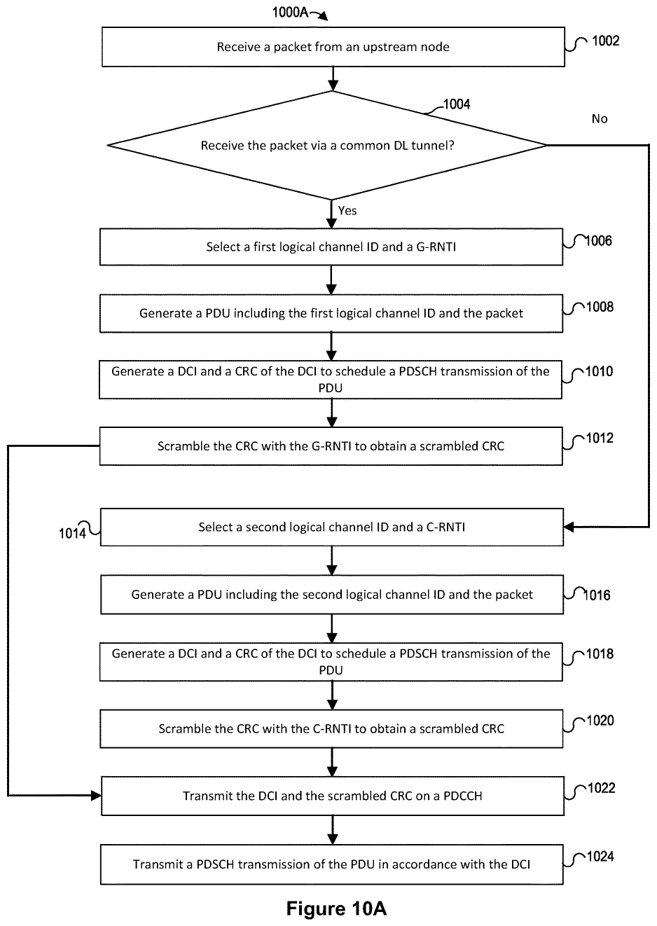

Referring now to FIG. 9, an example method 900 for selecting a first logical channel identifier or a second logical channel identifier for a data packet depending on whether the tunnel via which the data packet arrived has a first transport-layer configuration or a second transport-layer configuration can be implemented in a RAN node of this disclosure (e.g., base station 104), in an example. The method 900 begins at block 902, where a RAN node configures a first DL transport layer configuration, including first transport layer information, to receive packets from an upstream node. At block 904, the RAN node configures a second DL transport layer configuration, including second transport layer information, to receive packets from the upstream node. At block 906, the RAN node receives a DL tunnel packet including particular transport layer information and a particular data packet from the upstream node (e.g., events 518, 524, 526, 538, 544, 546, 564, 566). At block 908, the RAN node determines whether the particular transport layer information from the DL tunnel packet is the first transport layer information or the second transport layer information. If the particular transport layer information is the first transport layer information, the method 900 proceeds to block 910, which includes blocks 806, 808, and 810 as discussed above with respect to FIGS. 8A and 8B. If the particular transport layer information is the second transport layer information, the method 900 proceeds to block 912, which includes blocks 812, 814, and 816 as discussed above with respect to FIGS. 8A and 8B.

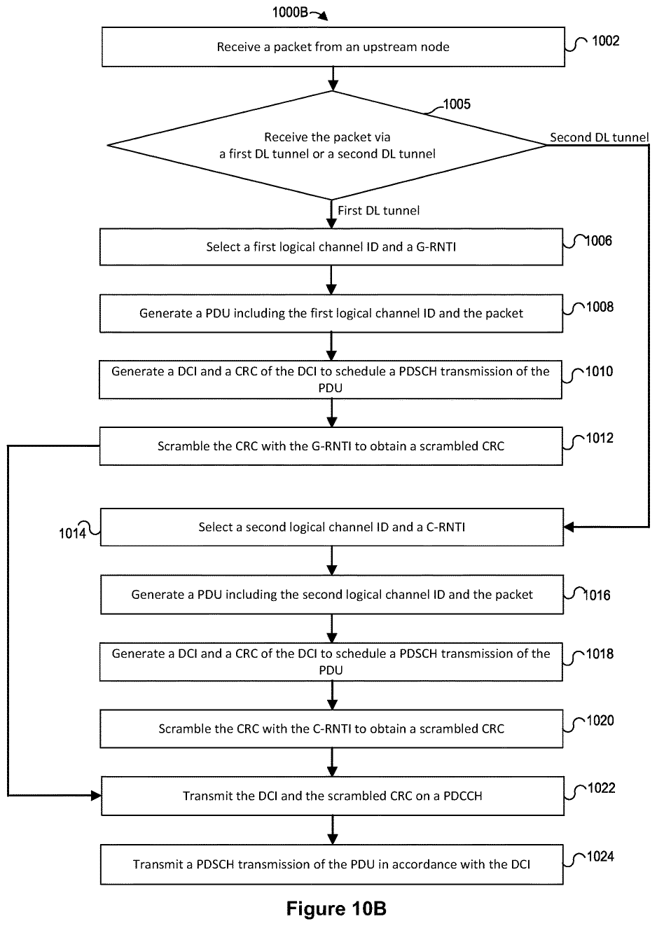

Referring now to FIG. 10A, an example method 1000A for selecting a group Network Temporary Identifier (G-RNTI) and a first logical channel, or a UE-specific RNTI (C-RNTI) and a second logical channel, for a data packet depending on whether the data packet arrived via a common or UE-specific tunnel can be implemented in a RAN node of this disclosure (e.g., base station 104 or DU 174), in an example. The method 1000A begins at block 1002, where the RAN node receives a data packet from an upstream node (e.g., events 518, 524, 526, 538, 544, 546, 564, 566). At block 1004, the RAN node determines whether the data packet was received via a common DL tunnel.

If the data packet was received via a common DL tunnel, at block 1006, the RAN node selects a first logical channel ID and a G-RNTI. At block 1008, the RAN node generates a PDU including the first logical channel ID and the data packet. At block 1010, the RAN node generates a DCI and a CRC of the DCI to schedule a PDSCH transmission of the PDU. At block 1012, the RAN node scrambles the CRC with the G-RNTI to obtain a scrambled CRC.

If the data packet was not received via a common DL tunnel (e.g., if the data packet was received via a UE-specific DL tunnel, or via a control plane message), at block 1014, the RAN node selects a second logical channel ID and a C-RNTI. At block 1016, the RAN node generates a PDU including the second logical channel ID and the data packet. At block 1018, the RAN node generates a DCI and a CRC of the DCI to schedule a PDSCH transmission of the PDU. At block 1020, the RAN node scrambles the CRC with the C-RNTI to obtain a scrambled CRC.

In any case, after block 1012 or block 1020, respectively, the method 1000A proceeds to block 1022, where the RAN node transmits the DCI and the scrambled CRC on a PDCCH. At block 1024, the RAN node transmits a PDSCH transmission of the PDU in accordance with the DCI.

Referring now to FIG. 10B, an example method 1000B for selecting a G-RNTI and a first logical channel, or a C-RNTI and a second logical channel, for a data packet depending on whether the data packet arrived via a first or second tunnel, can be implemented in a RAN node of this disclosure (e.g., base station 104 or DU 174), in an example. The method 1000B is generally similar to the method 1000A, except after block 1002, instead of proceeding to block 1004 as in the method 1000A, the method 1000B proceeds to block 1005, where the RAN node determines whether the data packet was received via a first DL tunnel or a second DL tunnel.

If the data packet was received via the first DL tunnel, at block 1006, the RAN node selects a first logical channel ID and a G-RNTI. At block 1008, the RAN node generates a PDU including the first logical channel ID and the data packet. At block 1010, the RAN node generates a DCI and a CRC of the DCI to schedule a PDSCH transmission of the PDU. At block 1012, the RAN node scrambles the CRC with the G-RNTI to obtain a scrambled CRC.

If the data packet was not received via the second DL tunnel, at block 1014, the RAN node selects a second logical channel ID and a C-RNTI. At block 1016, the RAN node generates a PDU including the second logical channel ID and the data packet. At block 1018, the RAN node generates a DCI and a CRC of the DCI to schedule a PDSCH transmission of the PDU. At block 1020, the RAN node scrambles the CRC with the C-RNTI to obtain a scrambled CRC.

In any case, after block 1012 or block 1020, respectively, the method 1000A proceeds to block 1022, where the RAN node transmits the DCI and the scrambled CRC on a PDCCH. At block 1024, the RAN node transmits a PDSCH transmission of the PDU in accordance with the DCI.

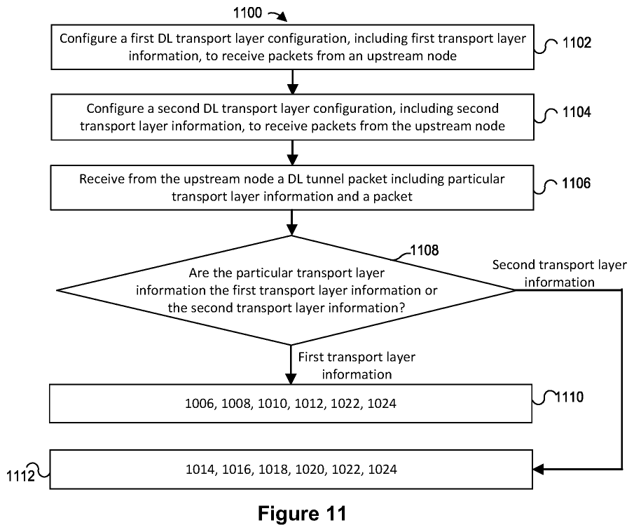

Referring now to FIG. 11, an example method 1100 for selecting a G-RNTI and a first logical channel, or a C-RNTI and a second logical channel, for a data packet depending on whether the tunnel via which the data packet arrived has a first transport-layer configuration or a second transport-layer configuration can be implemented in a RAN node of this disclosure (e.g., base station 104), for example. The method 1100 begins at block 1102, where a RAN node configures a first DL transport layer configuration, including first transport layer information, to receive packets from an upstream node. At block 1104, the RAN node configures a second DL transport layer configuration, including second transport layer information, to receive packets from the upstream node. At block 1106, the RAN node receives a DL tunnel packet including particular transport layer information and a particular data packet from the upstream node (e.g., events 518, 524, 526, 538, 544, 546, 564, 566). At block 1108, the RAN node determines whether the particular transport layer information from the DL tunnel packet is the first transport layer information or the second transport layer information. If the particular transport layer information is the first transport layer information, the method 1100 proceeds to block 1110, which includes blocks 1006, 1008, 1010, 1012, 1022, and 1024, as discussed above with respect to FIGS. 10A and 10B If the particular transport layer information is the second transport layer information, the method 1100 proceeds to block 1112, which includes blocks 1014, 1016, 1018, 1020, 1022, and 1024, as discussed above with respect to FIGS. 1000A and 1000B.

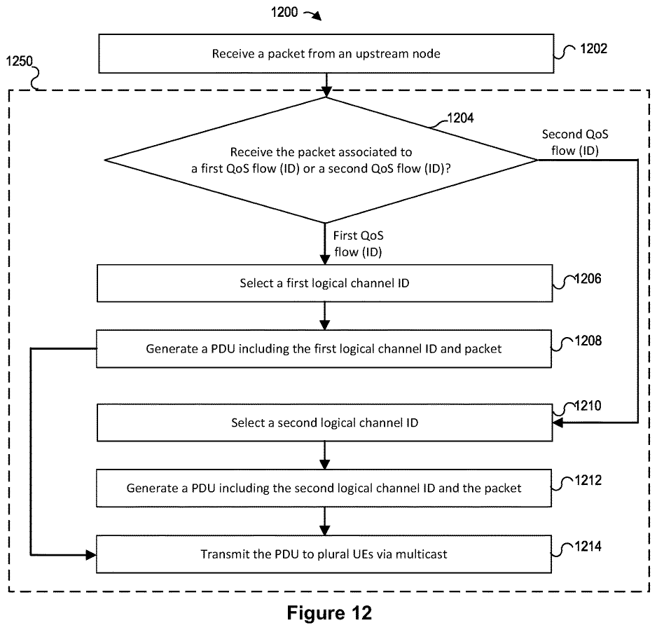

Referring now to FIG. 12, an example method 1200 for selecting a first logical channel identifier or a second logical channel identifier for a data packet depending on whether the data packet is associated with a first Quality of Service (QOS) flow identifier or a second QoS flow identifier can be implemented in a RAN node of this disclosure (e.g., base station 104 or DU 174), in an example. The method 1200 begins at block 1202, when a RAN node receives a data packet from an upstream node (e.g., events 518, 524, 526, 538, 544, 546, 564, 566). The method 1200 may then proceed to block 1250, which includes blocks 1204, 1206, 1208, 1210, 1212, and 1214. At block 1204, the RAN node determines whether the data packet that was received is associated with a first QoS flow identifier or a second QoS flow identifier.

If the data packet is associated with the first QoS flow identifier, the method 1200 proceeds to block 1206, where the RAN node selects a first logical channel ID. At block 1208, the RAN node generates a PDU including the first logical channel ID and the data packet.

If the data packet is associated with the second QoS flow identifier, the method 1200 proceeds to block 1210, where the RAN node selects a second logical channel ID. At block 1212, the RAN node generates a PDU including the second logical channel ID and the data packet.

In any case, after block 1208 or block 1212, respectively, the method 1200 proceeds to block 1214, where the RAN node transmits the PDU to multiple UEs via multicast.

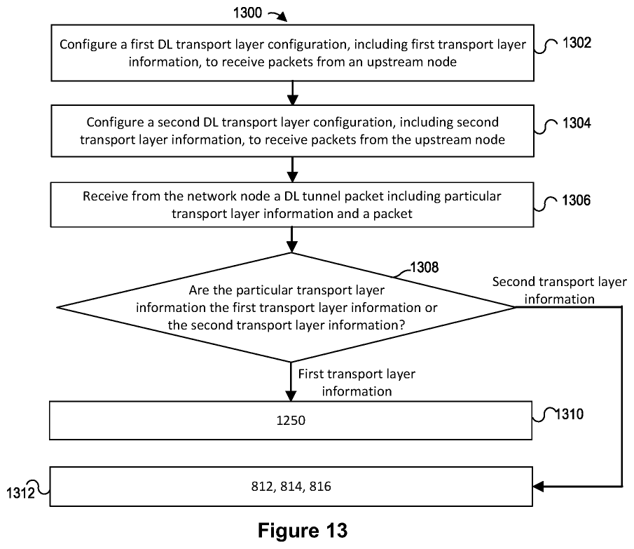

Referring now to FIG. 13, an example method 1300 for determining whether to select a first logical channel identifier or a second logical channel identifier for a data packet depending on whether the data packet is associated with a first QoS flow identifier or a second QoS flow identifier, or to select the second logical channel for the data packet, depending on whether the tunnel via which the data packet arrived has a first transport-layer configuration or a second transport-layer configuration, can be implemented in a RAN node of this disclosure (e.g., base station 104), in an example. The method 1300 begins at block 1302, where a RAN node configures a first DL transport layer configuration, including first transport layer information, to receive packets from an upstream node. At block 1304, the RAN node configures a second DL transport layer configuration, including second transport layer information, to receive packets from the upstream node. At block 1306, the RAN node receives a DL tunnel packet including particular transport layer information and a particular data packet from the upstream node (e.g., events 518, 524, 526, 538, 544, 546, 564, 566). At block 1308, the RAN node determines whether the particular transport layer information from the DL tunnel packet is the first transport layer information or the second transport layer information. If the particular transport layer information is the first transport layer information, the method 900 proceeds to block 1310, which includes block 1250 (which in turn includes blocks 1204, 1206, 1208, 1210, 1212, and 1214 as discussed above with respect to FIG. 12). If the particular transport layer information is the second transport layer information, the method 1300 proceeds to block 1312, which includes blocks 812, 814, and 816 as discussed above with respect to FIGS. 8A and 8B.

In different implementations, a RAN node can consider any suitable number of factors to select a transmission scheme, and the RAN node can execute blocks 1308, 1310, and 1312 in any suitable order to effectively assign different priorities to these factors.

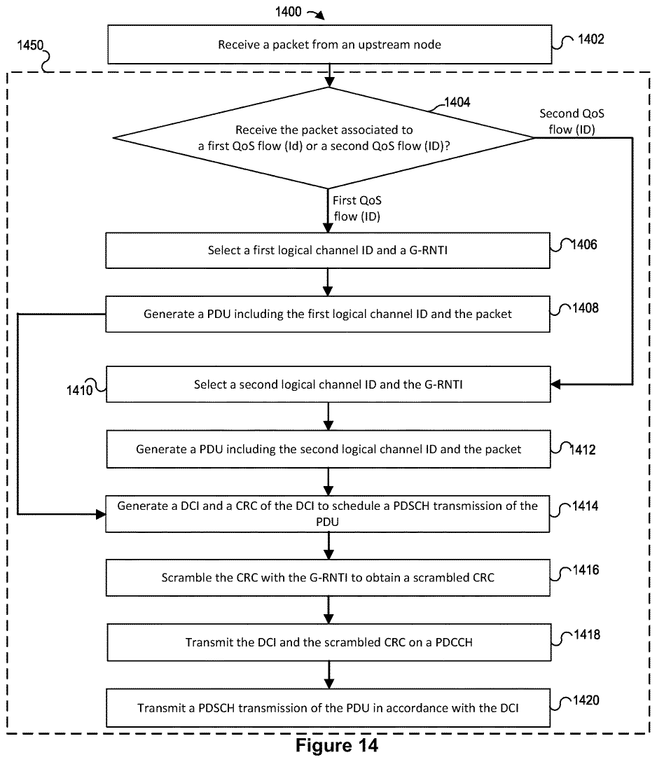

Referring now to FIG. 14, an example method 1400 for selecting a first logical channel identifier and a G-RNTI, or a second logical channel identifier and the G-RNTI, for a data packet depending on whether the data packet is associated with a first QoS flow identifier or a second QoS flow identifier, can be implemented in a RAN node of this disclosure (e.g., base station 104 or DU 174), in an example. The method 1400 begins at block 1402 when a RAN node receives a data packet from an upstream node. The method 1400 then proceeds to block 1450, which includes blocks 1404, 1406, 1408, 1410, 1412, 1414, 1416, 1418, and 1420. At block 1404, the RAN node determines whether the data packet that was received is associated with a first QoS flow identifier or a second QoS flow identifier.

If the data packet is associated with the first QoS flow identifier, the method 1400 proceeds to block 1406, where the RAN node selects a first logical channel ID and a G-RNTI. At block 1408, the RAN node generates a PDU including the first logical channel ID and the data packet.

If the data packet is associated with the second QoS flow identifier, the method 1400 proceeds to block 1410, where the RAN node selects a second logical channel ID and the G-RNTI. At block 1412, the RAN node generates a PDU including the second logical channel ID and the data packet.

In any case, after block 1408 or block 1412, respectively, the method 1400 proceeds to block 1414, where the RAN node generates a DCI and a CRC of the DCI to schedule a PDSCH transmission of the PDU. At block 1416, the RAN node scrambles the CRC with the G-RNTI to obtain a scrambled CRC. At block 1418, the RAN node transmits the DCI and the scrambled CRC on a PDCCH. At block 1420, the RAN node transmits a PDSCH transmission of the PDU in accordance with the DCI.

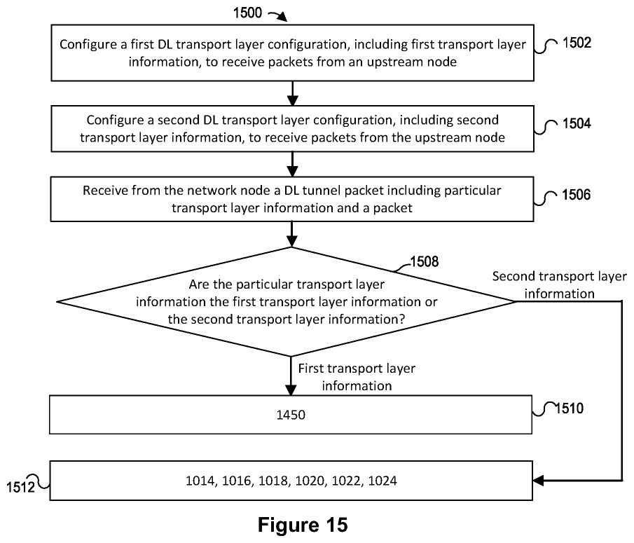

Referring now to FIG. 15, an example method 1500 for determining whether to select a first logical channel identifier and a G-RNTI, or a second logical channel identifier and the G-RNTI, for a data packet depending on whether the data packet is associated with a first QoS flow identifier or a second QoS flow identifier, or to select the second logical channel and a C-RNTI for the data packet, depending on whether the tunnel via which the data packet arrived has a first transport-layer configuration or a second transport-layer configuration, can be implemented in a RAN node of this disclosure (e.g., base station 104), in an example.

The method 1500 begins at block 1502, where a RAN node configures a first DL transport layer configuration, including first transport layer information, to receive packets from an upstream node. At block 1504, the RAN node configures a second DL transport layer configuration, including second transport layer information, to receive packets from the upstream node. At block 1506, the RAN node receives a DL tunnel packet including particular transport layer information and a particular data packet from the upstream node. At block 1508, the RAN node determines whether the particular transport layer information from the DL tunnel packet is the first transport layer information or the second transport layer information. If the particular transport layer information is the first transport layer information, the method 1500 proceeds to block 1510, which includes block 1450 (which in turn includes blocks 1404, 1406, 1408, 1410, 1412, 1414, 1416, 1418, and 1420, as discussed above with respect to FIG. 14). If the particular transport layer information is the second transport layer information, the method 1500 proceeds to block 1512, which includes blocks 1014, 1016, 1018, 1020, 1022, and 1024, as discussed above with respect to FIGS. 10A and 10B.

The following list of examples reflects a variety of the implementations explicitly contemplated by the present disclosure:

Example 1. A method for managing transmission of multicast and/or broadcast services (MBS), implemented in a node of a radio access network (RAN), the method comprising: receiving, by processing hardware from an upstream node, an MBS data packet via a downlink (DL) tunnel; selecting, by the processing hardware and based on one or more properties of the DL tunnel, a multicast scheme for transmitting the MBS data packet to multiple UEs; and transmitting, by the processing hardware, the data packet via a radio interface to the multiple UEs using the multicast scheme, in accordance with the selecting.

Example 2. The method of example 1, wherein the selecting includes: determining that the DL tunnel is a common DL tunnel via which the upstream node is configured to transmit a single copy of the MBS data packet to the multiple UEs, via the node. Example 3. The method of example 2, wherein: the receiving, the selecting, and the transmitting occur in a first instance; the method further comprising, in a second instance: receiving a second data packet via a UE-specific tunnel; selecting, based on the UE-specific tunnel, a unicast scheme for transmitting the second data packet to at least one certain UE; and transmitting the second data packet via the radio interface to the at least one certain UE using the unicast scheme.

Example 4. The method of example 1, wherein the selecting includes: determining that the DL tunnel is a first one of a plurality of DL tunnels configured at the node.

Example 5. The method of example 4, wherein: the receiving, the selecting, and the transmitting occur in a first instance; the method further comprising, in a second instance: receiving a second data packet via a second one of a plurality of DL tunnels configured at the node; selecting, based on the second one of the plurality of DL tunnels, a unicast scheme for transmitting the second data packet to at least one certain UE; and transmitting the second data packet via the radio interface to the at least one certain UE using the unicast scheme.

Example 6. The method of example 1, wherein the selecting includes: determining that the DL tunnel has a first one of a plurality of transport-layer configurations at the node.

Example 7. The method of example 6, wherein: the receiving, the selecting, and the transmitting occur in a first instance; the method further comprising, in a second instance: receiving a second data packet via a second of DL tunnel; determining that the second DL tunnel has a second one of the plurality of transport-layer configurations at the node; and transmitting the second data packet via the radio interface to at least one certain UE using the unicast scheme.

Example 8. The method of any of the preceding examples, further comprising: selecting a logical channel identifier based on the one or more properties of the DL tunnel.

Example 9. The method of example 8, wherein the transmitting includes: including the MBS data packet and the logical channel identifier in a Protocol Data Unit (PDU).

Example 10. The method of example 8, wherein the logical channel selected for the MBS data packet is a multicast traffic channel (MTCH).

Example 11. The method of any of examples 8-10, wherein: selecting the logical channel identifier is further based on a quality of service (QOS) flow identifier of the MBS data packet.

Example 12. The method of any of examples 1-10, further comprising: selecting a Radio Network Temporary Identifier (RNTI) based on the one or more properties of the DL tunnel.

Example 13. The method of example 11, wherein the RNTI selected for the MBS data packet is group RNTI (G-RNTI).

Example 14. The method of any of example 12 or 13, wherein: selecting the RNTI further based on a QoS flow identifier of the MBS data packet.

Example 15. The method of any of the preceding examples, wherein: the node is a distributed unit (DU) of a distributed base station, and the upstream node is a central unit (CU) of the distributed base station.

Example 16. The method of any of examples 1-14, wherein: the node is a distributed unit (DU) of a distributed base station, and the upstream node is a user-plane function of the CU (CU-UP).

Example 17. The method of any of examples 1-14, wherein: the node is a distributed unit (DU) of a distributed base station, and the upstream node is a control-plane function of the CU (CU-CP).

Example 18. The method of any of examples 1-14, wherein: the node is a base station, and the upstream node is a user-plane function (UPF) of the core network (CN).

Example 19. The method of any of examples 1-14, wherein: the node is a base station, and the upstream node is an Access and Mobility Management Function (AMF) of the CN.

Example 20. A method for managing transmission of data packets, implemented in a node of a radio access network (RAN), the method comprising: receiving, by processing hardware from an upstream node, an MBS data packet associated with a quality-of-service (QoS) flow; selecting, by the processing hardware and based on the QoS flow, a logical channel on a radio interface; and multicasting, by the processing hardware on the logical channel, the MBS data packet to multiple UEs.

Example 21. The method of example 20, wherein: receiving the MBS data packet includes receiving the MBS data packet via a DL tunnel; and selecting the logical channel based on the QoS flow is in response to determining that the DL tunnel has a first one of a plurality of transport-layer configurations.

Example 22. The method of example 21, wherein the determining further includes determining that the DL tunnel is a common DL tunnel via which the upstream node is configured to transmit a single copy of the MBS data packet to the multiple UEs.

Example 23. The method of any of examples 20-22, further comprising: selecting, by the processing hardware and based on the QoS flow, an RNTI.

Example 24. The method of example 23, wherein selecting the RNTI includes selecting a G-RNTI.

Example 25. A network node comprising processing hardware and configured to implement a method of any of the preceding examples.

1. A method for managing transmission of multicast and/or broadcast services (MBS), performed by a distributed unit (DU) of a distributed base station in a radio access network (RAN), the method comprising:
receiving, by the DU and from a central unit (CU) of the distributed base station, a data packet via a downlink (DL) tunnel;
determining, by the DU, whether the data packet was received via a common downlink (DL) tunnel connecting the CU and the DU and via which the CU transmits MBS data packets to multiple User Equipments (UEs);
when the DU determines that the DU received the data packet from the CU via a common downlink (DL) tunnel, selecting, by the DU, a multicast scheme for transmitting the data packet to the multiple UEs;
when the DU determines that the DU did not receive the data packet from the CU via the common downlink tunnel, selecting, by the DU, a unicast scheme for transmitting the data packet to a particular UE; and
transmitting the data packet via a radio interface to the multiple UEs or to the particular UE using the selected scheme.

2. The method of claim 1, wherein the receiving of the data packet via the DL tunnel includes receiving the data packet via a common DL tunnel via which the CU is configured to transmit a single copy of the data packet to the multiple UEs, via the DU.

3. The method of claim 1, wherein the receiving of the data packet via the DL tunnel includes receiving the data packet via a UE-specific tunnel.

4. The method of claim 1, wherein the selecting includes:
determining that the DL tunnel is a first DL tunnel of a plurality of DL tunnels configured at the DU.

5. The method of claim 4, wherein:
the receiving of the data packet via the first DL tunnel includes receiving the data packet via the common DL tunnel;
the receiving of the data packet via the common DL tunnel, the selecting, and the transmitting occur in a first instance; and
the method further comprising, in a second instance:
receiving a second data packet via a second DL tunnel of the plurality of DL tunnels;
selecting, based on the second DL tunnel, the unicast scheme for transmitting the second data packet to at least one certain UE; and
transmitting the second data packet via the radio interface to the at least one certain UE using the unicast scheme.

6. The method of claim 1, further comprising:
selecting a logical channel identifier based on whether the data packet was received at the DU via the common DL tunnel.

7. The method of claim 6, wherein the transmitting includes:
including the data packet and the logical channel identifier in a Protocol Data Unit (PDU).

8. The method of claim 6, wherein the logical channel selected for the data packet is a multicast traffic channel (MTCH).

9. The method of claim 6, wherein:
the selecting of the logical channel identifier is further based on a quality of service (QOS) flow identifier of the data packet.

10. The method of claim 1, further comprising:
selecting a Radio Network Temporary Identifier (RNTI) based on whether the data packet was received at the DU via the common DL tunnel.

11. The method of claim 10, wherein the RNTI selected for the data packet is group RNTI (G-RNTI).

12. The method of claim 10, wherein the selecting of the RNTI is further based on a QoS flow identifier of the data packet.

13. The method of claim 1, further comprising at least one of:
receiving, by the DU and from the CU, a request to set up the common DL tunnel, and responsive to the received request to set up the common DL tunnel, sending, by the DU and to the CU, a first DU CL transport layer configuration to configure the common DL tunnel; or
receiving, by the DU and from the CU, a request of a context of the UE, and responsive to the received request for the UE context, sending, by the DU and to the CU, a second DU DL transport layer configuration to configure the UE-specific DL tunnel.

14. A method for managing transmission of data packets, performed by a node of a radio access network (RAN), the method comprising:
receiving, by the node and from an upstream node, a data packet associated with a quality-of-service (QOS) flow;
when the QoS flow associated with the received data packet is a first QoS flow, selecting, by the node, a first logical channel on a radio interface and transmitting, on the first logical channel, the data packet to multiple UEs via multicast; and
when the QoS flow associated with received data packet is a second QoS flow, selecting, by the node, a second logical channel on the radio interface and transmitting, on the second logical channel, the data packet to multiple UEs via unicast.

15. The method of claim 14, wherein:
receiving the data packet includes receiving the data packet via a DL tunnel; and
selecting the first logical channel when the received data packet is associated with the first QoS flow is in response to determining that the DL tunnel has a first one of a plurality of transport-layer configurations.

16. The method of claim 15, wherein the determining further includes determining that the DL tunnel is a common DL tunnel via which the upstream node is configured to transmit a single copy of the data packet to the multiple UEs.

17. The method of claim 14, further comprising:
when the received data packet is associated with the second QoS flow, selecting a UE-specific RNTI.

18. The method of claim 14, further comprising:
when the received data packet is associated with the first QoS flow, selecting a G-RNTI.

19. A network node configured to implement the method of claim 1.

20. A network node configured to implement the method of claim 14.
